(19) United States
(12) Patent Application Publication
(10) Pub. No.: US 2012/0158588 A1
(43) Pub. Date: Jun. 21, 2012

(54) RECEPTION PROCESS SYSTEM AND METHOD

(75) Inventor: Tomoyuki KUBO, Himeji-shi (JP)

(73) Assignee: GLORY LTD., Himeji-shi (JP)

(21) Appl. No.: 12/974,987

(22) Filed: Dec. 21, 2010

(51) Int. Cl. G06Q 40/00

(52) U.S. Cl. 705/44

(57) ABSTRACT

A system is provided for processing a deposit/withdrawal request from a customer. A bank terminal includes an identifying unit that extracts check information from the check image and extracts slip information from the slip image, an input unit that receives an input information, and a confirmation determining unit that determines, based on at least one of the check information, the slip information, and the input information from the input unit, whether or not a reconfirmation for at least one of the information is necessary. A communication unit transmits the check information, the slip information, and the determination result to a center terminal having a second display unit. The second display unit displays the check information and the slip information and displays information determined necessary to be reconfirmed in a way so as to be distinguished from information determined not necessary to be reconfirmed.

### BACKGROUND OF THE INVENTION

1. Field of the Invention

The present invention relates to a reception process system and method for banks. In particular, the present invention is a reception process system and method for banks to process a check and a slip received from a teller of a bank.

In a conventional bank, the teller checks whether the slip is a deposit slip or a withdrawal slip when a teller receives a check and a slip from a customer at a teller's window. The teller confirms whether entries of the slip match entries of the check by referring to an original. In a deposit process, after the confirmation is performed by the teller, the teller shows the amount of received money to the customer. In a withdrawal process, the teller manually calculates a service charge based on the entries of the withdrawal slip and/or the check. The teller shows the customer the service charge and the amount of transaction. When the customer approves the amount, the amount described in the check is paid or deposited the money into an account of the customer.

When the teller receives money or a slip from a customer, the teller puts the money in a currency processing device. The teller confirms whether an amount of money calculated by the currency processing device matches the entry of the slip. After the confirmation is performed by the teller, the teller deposits the amount of money calculated by the currency processing device into an account of the customer.

As described above, the teller performs the reception process for the customer. When the teller's services are finished, a bank clerk, for example, a supervisor such as a manager who manages the teller, checks the contents of the reception process performed by the teller, so as to determine whether a deposit process or a withdrawal process is appropriately executed. When the supervisor determines that the deposit process or the withdrawal process is appropriately executed, an image of the check generated by the window (teller) or the back office (supervisor) and deposit/withdrawal information are transmitted to a center which manages data of the bank.

In this case, a bank clerk of the center confirms the images of the check and the deposit/withdrawal information. Upon completion of this final confirmation by the bank clerk of the center, the image of the check, and the deposit/withdrawal information are stored in a server, a database, or the like. The stored images are disclosed on the web site of the bank at a later date to make it possible for the customer to confirm the images online.

In the deposit/withdrawal processes in a conventional bank, a teller confirms various pieces of described information on a check, a slip for the check, a slip for money, and the like. When the teller's services are finished, a supervisor confirms the same information again. In this manner, in a conventional reception process, since the teller and the supervisor must confirm the same information, a disadvantageously long time is needed to confirm the deposit/withdrawal processes. Furthermore, when an error or the like is found in the deposit/withdrawal processes processed by the teller, a recovery process for the error is cumbersome. For this reason, a very long time is disadvantageously needed to recover the error.

The teller calculates a service charge on the basis of information on the withdrawal slip and/or information on the check, and shows the customer the amount of money from which the service charge has been subtracted when the teller receives a check cashing request from the customer at the teller window. In this case, service charges vary depending on amounts of transaction, withdrawal banks, and the like. In this manner, in the conventional withdrawal process, since service charges vary depending on conditions, a service charge may be erroneously calculated, or a long time is disadvantageously needed to calculate a service charge and a withdrawal amount from which the charge has been subtracted.

Furthermore, after a deposit/withdrawal process is confirmed by a supervisor, a final confirmation is performed in the center. In this case, the bank clerk confirms the images generated at the teller window or the back office and/or the deposit/withdrawal information confirmed at the teller window and/or the back office. In other words, since all pieces of information processed by all the tellers are gathered together, a huge amount of time is required to process the various pieces of information in the center.

### SUMMARY OF THE INVENTION

The present invention has been made in consideration of the above problems, with its object being to provide a reception process system and method which can efficiently perform a reception process.

According to one aspect of the present invention, a reception process system is for handling a deposit/withdrawal request from a customer. The reception process system is comprised of a scanner, a bank terminal, and a center terminal. The scanner generates a check image based on check received from the customer and generates a slip image based on a slip related to the check.

The bank terminal includes an identifying unit, a first display unit, an input unit, a confirmation determining unit, and a communication unit. The identifying unit extracts check information from the check image and extracts slip information from the slip image. The first display unit displays the check information and the slip information. The input unit receives an input information. The confirmation determining unit determines, based on at least one of the check information, the slip information, and the input information from the input unit, whether or not a reconfirmation for at least one of the check information, the slip information, and the input information is necessary. The communication unit transmits the check information, the slip information, and the determination result determined by the confirmation determining unit to an external device. The center terminal includes a second display unit. The second display unit displays the check information and the slip information received from the bank terminal and displays information determined necessary to be reconfirmed in a way so as to be distinguished from information determined not necessary to be reconfirmed.

According to another aspect of the present invention, a reception process method is for processing a deposit/withdrawal request from a customer, includes:

generating a check image based on check received from the customer and generating a slip image based on a slip related to the check;

extracting check information from the check image and extracts slip information from the slip image;

displaying the check information and the slip information on a first display unit;

receiving an input information;

determining whether or not a reconfirmation for at least one of the check information, the slip information, and the input information is necessary, based on at least one of the check information, the slip information, and the input information;

transmitting the check information, the slip information, and the determination result of the reconfirmation to an external device; and

displaying the check information and the slip information on a second display unit and displaying information determined necessary to be reconfirmed in a way so as to be distinguished from information determined not necessary to be reconfirmed.

According to the reception process system and the method, in the bank terminal, the check information and the deposit slip information are extracted from the check image and the deposit slip image. It is determined whether the check information, the slip information, and input information are necessary to be reconfirmed. The pieces of information and the determination result are transmitted to an external device. In the center terminal, the information determined necessary to be reconfirmed is displayed on the display differently of the information determined not necessary to be reconfirmed.

Accordingly, a bank clerk of the center needs not confirm all the information, but needs to confirm only the information which he/she is requested to confirm. For this reason, the bank clerk of the center can efficiently perform the confirmation within a short period of time. For example, the information which has been confirmed by the supervisor is distinguished from the information to be confirmed by the bank clerk of the center, and the bank clerk of the center checks only the information which he/she is requested to confirm. In this manner, the confirmation by the bank clerk of the center can be efficiently performed within a short period of time.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a diagram showing a schematic configuration of a reception process system according to first and second embodiments of the present invention.

FIG. 2 is a diagram showing a basic configuration of each terminal in the reception process system.

FIG. 3 is a diagram showing a basic configuration of a scanner in the reception process system.

FIG. 4 is a diagram showing a basic configuration of a currency processing device in the reception process system.

FIG. 5 is a functional block diagram in the reception process system.

FIG. 6 is a diagram for illustrating an image displayed on a display.

FIG. 7 is a diagram showing a format of a check.

FIG. 8 is a diagram showing a format of a deposit/withdrawal slip.

FIG. 9 is a diagram showing a notification image.

FIG. 10 is a diagram showing a corresponding relationship between item information of a check and data.

FIG. 11 is a diagram showing a corresponding relationship between item information of a slip and data.

FIG. 12 is a diagram showing an arrangement of information displayed on a display.

FIG. 13 is a diagram showing identification conditions of flags.

FIG. 14 is a process flow in a reception process system (server).

FIG. 15 is a process flow in the reception process system in a deposit mode (teller terminal).

FIG. 16 is a process flow in the reception process system in the deposit mode (teller terminal).

FIG. 17 is a process flow in the reception process system (management terminal).

FIG. 18 is a process flow in the reception process system (center terminal).

FIG. 19 is a process flow in the reception process system (scanner).

FIG. 20 is a process flow in the reception process system in a withdrawal mode (currency processing device).

FIG. 21 is a process flow in the reception process system in the withdrawal mode (teller terminal).

FIG. 22 is a process flow in the reception process system in the withdrawal mode (teller terminal).

FIG. 23 is a diagram showing a format of a slip for money in the second embodiment.

FIG. 24 is a diagram for illustrating an image displayed on a display.

FIG. 25 is a diagram showing identification conditions of flags.

FIG. 26 is a process flow in the reception process system in the deposit mode (teller terminal).

FIG. 27 is a process flow in the reception process system in the deposit mode (currency processing device).

### DETAILED DESCRIPTION OF THE INVENTION

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### First Embodiment

[Description of Devices Included in Reception Process System]

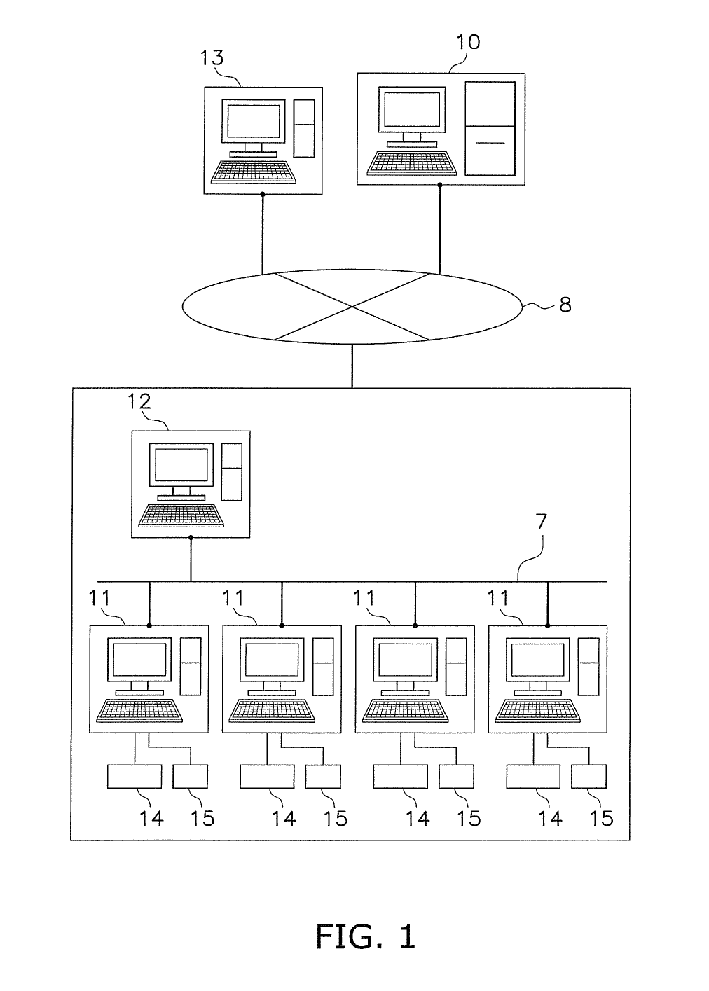

A reception process system is a system that processes a check and a slip received by a teller of a bank from a customer. Devices included in the reception process system for banks will be described below. The reception process system for banks, as shown in FIG. 1, for example, has a server 10, a teller terminal 11, a supervisor terminal 12, a center terminal 13, a scanner 14, and a currency processing device 15.

As a network 7, an internal network such as a LAN (Local Area Network) is used. As a network 8, an external network such as the internet is used. For example, the teller terminal 11 and the supervisor terminal 12 are connected to each other through the network 7. The server 10, the center terminal 13, the teller terminal 11, and the supervisor terminal 12 are connected to each other through the network 8.

An example in which the scanner 14 and the currency processing device 15 are connected to the teller terminal 11 is described here. However, at least one of the scanner 14 and the currency processing device 15 may also be connected to the network 7.

### <Server>

The server 10 provides various services to a client, for example, at least one of the teller terminal 11 and the supervisor terminal 12. The server 10 also provides various services to the center terminal 13. For example, the server 10 executes a calculating process, a data transmitting process, and the like in response to requests from each of the terminals 11, 12, and 13. The server 10 also stores data received from the terminals 11, 12, and 13.

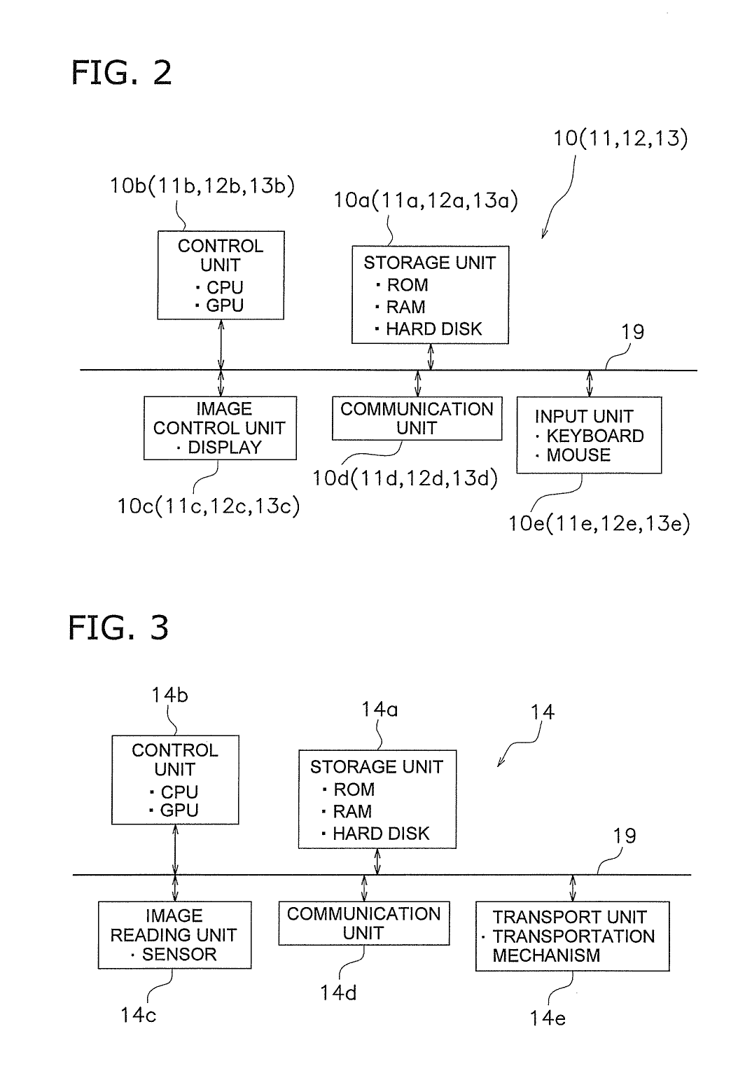

The server 10, for example, as shown in FIG. 2, has a storage unit 10a, a control unit 10b, an image control unit 10c, a communication unit 10d, and an input unit 10e. The units are connected to each other through a bus 19.

The server storage unit 10a stores various data. For example, the server storage unit 10a stores a basic program, basic data, a basic parameter, various other programs, various other data, data in process, and the like temporarily and/or for a long term. The server storage unit 10a, for example, includes a ROM (Read Only Memory), a RAM (Random Access Memory), and an auxiliary recording device, such as a hard disk.

The server control unit 10b controls various processes in the server 10. In the control unit 10b, a program related to control and calculation is read from the server storage unit 10a to perform various controls and various calculations. The results thereof are recorded in the server storage unit 10a. The server control unit 10b also performs various image controls and image processing and records the results in the server storage unit 10a. The server control unit 10b includes, for example, a CPU (Central Processing Unit) and a GPU (Graphics Processing Unit). In case that the server control unit 10b doesn't include the GPU, controls and processes related to an image are performed by the CPU.

The server image control unit 10c performs processes related to display of an image. The server image control unit 10c includes, for example, a display. The server image control unit 10c outputs the image controlled and processed in the server control unit 10b to the display as a still image and/or a moving image. The image data is recorded in the server storage unit 10a and can be arbitrarily read from the server storage unit 10a.

The communication unit 10d executes controls related to communication connection of a terminal. The server communication unit 10d controls and transmits a connection signal to connect one terminal to another terminal in response to an instruction from the server control unit 10b. The server communication unit 10d controls and transmits a transmission signal to transmit various data from one terminal to another terminal in response to an instruction from the server control unit 10b.

The server input unit 10e controls various input instructions. The server input unit 10e includes, for example, a keyboard and a mouse. The server input unit 10e issues an input signal when an operator inputs various instructions through the keyboard and the mouse. In this case, a process corresponding to the input signal is executed in at least one of the server control unit 10b, the server storage unit 10a, the server image control unit 10c, and the server communication unit 10d.

### <Teller Terminal, Supervisor Terminal, Center Terminal>

The teller terminal 11 is a terminal operated by a teller. The supervisor terminal 12 is a terminal operated by a supervisor which manages the teller on the back office. The center terminal 13 is a terminal which supports the teller and the supervisor on the back office.

The teller terminal 11 has, for example, a storage unit 11a, a control unit 11b, an image control unit 11c, a communication unit 11d, and an input unit 11e (see FIG. 2). The supervisor terminal 12, for example, has a storage unit 12a, a control unit 12b, an image control unit 12c, a communication unit 12d, and an input unit 12e. Furthermore, the center terminal 13, for example, has a storage unit 13a, a control unit 13b, an image control unit 13c, a communication unit 13d, and an input unit 13e.

The storage units 11a, 12a, and 13a of the terminals 11, 12, and 13 store various data. The control units 11b, 12b, and 13b of the terminals 11, 12, and 13 control various processes in the respective terminals. The image control units 11c, 12c, and 13c of the terminals 11, 12, and 13 perform processes related to display of an image. The communication units 11d, 12d, and 13d of the terminals 11, 12, and 13 execute controls to connect themselves to other terminals. The input units 11e, 12e, and 13e of the terminals 11, 12, and 13 control various input instructions. The configurations and the functions of the units described here are the same as those in the server 10 described above.

### <Scanner>

The scanner 14 is a device which reads an object, for example, an image, a paper, or the like, as digital data. The scanner 14, as shown in FIG. 3, for example, has a storage unit 14a, a control unit 14b, an image reading unit 14c, a communication unit 14d, and a transport unit 14e which conveys paper sheet including an image or a character. The paper sheet includes, for example, a check or a slip.

The scanner storage unit 14a stores various data. The control unit 14b executes various image controls and image processing. The scanner communication unit 14d executes controls to connect to another terminal. The configurations and the functions of the units described here are the same as those in the server 10. For this reason, a detailed explanation of the configurations and the functions of the units 14a, 14b, 14c, and 14d will not be made.

The image reading unit 14c reads an object, such as an image, a paper, or the like. The image reading unit 14c includes, for example, a sensor. The sensor reads an image, a paper, or the like as image data in response to an instruction from the scanner control unit 14b. At this time, the image data is recorded in the scanner storage unit 14a.

When an object to be read is set at a predetermined position, the scanner transport unit 14e conveys the object from the set position to the image reading unit 14c. After the object is read by the image reading unit 14c, the object is conveyed as described below. For example, the scanner transport unit 14e includes a transportation mechanism. The transportation mechanism conveys the object from the set position to the image reading unit 14c, and the image reading unit 14c reads the object. Thereafter, the object is conveyed to an escrow unit. After an approval process is performed, the object stored in the escrow unit is conveyed from the escrow unit to a storing unit.

The escrow unit is a component in which the scan object is temporarily stored, and is arranged inside or outside the scanner 14. The storing unit is a component in which the object in the escrow unit is stored at the end, and is arranged inside or outside the scanner 14.

When the escrow unit and the storing unit are arranged separately of the scanner, a flat-head scanner, a handy scanner, a scanner having a feeder, and the like can be used as the scanner 14, for example.

The scanner 14 may further include a magnetic-ink character reading unit. The magnetic-ink character reading unit includes, for example, a reader for MICR (Magnetic ink character recognition). The reader for MICR is a device that reads magnetic-ink characters (Magnetic Ink Characters) printed on a check. A character string constituted by a plurality of magnetic-ink characters is printed on the check. Information of the character string includes, for example, a bank code, an account number, and the like. An example in which a reader for MICR is built in the scanner 14 is described here. However, the reader for MICR may be prepared separately from the scanner 14.

<Currency processing Device>

The currency processing device 15 is a device that calculates an amount of banknotes and/or coins. In the currency processing device 15, when a teller and/or a customer puts banknotes and/or coins through a money inlet, the amount of the banknotes and/or the coins is calculated.

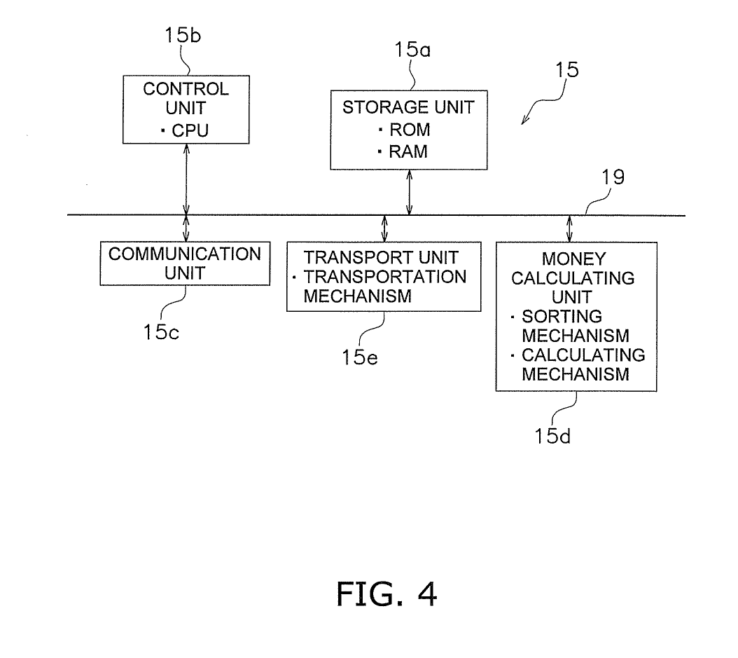

The currency processing device 15, as shown in FIG. 4, has a storage unit 15a, a control unit 15b, a communication unit 15c, a money calculating unit 15d, and a transport unit 15e. The storage unit 15a has no hard disk. The configurations and the functions of the storage unit 15a and the control unit 15b for the currency processing device are the same as those of the server storage unit 10a and the server control unit 10b. The configuration and the function of the communication unit 15c for the currency processing device are the same as those of the server communication unit 10d described above.

The money calculating unit 15d includes a sorting mechanism and a calculating mechanism. The sorting mechanism distinguishes banknotes inserted through the money inlet depending on the denominations of banknotes. Furthermore, the sorting mechanism distinguishes coins put through the money inlet depending on the denominations of coins. The calculating mechanism calculates the number of banknotes and the number of coins. Moreover, the amount of the banknotes and/or the coins calculated here is recorded in the storage unit 15a as the amount data of the banknotes and/or the amount data of the coins.

The transport unit 15e of the currency processing device conveys money. For example, the transport unit 15e of the currency processing device includes a transportation mechanism. The transportation mechanism conveys the money from the money inlet or a storage unit to an escrow unit. Furthermore, the transportation mechanism conveys the money from the escrow unit to a storing unit or an outlet. Moreover, the escrow unit is a component which temporarily stores the money after the calculation and is arranged inside the currency processing device 15. Moreover, the storing unit may be arranged inside or outside the currency processing device 15.

### [Explanation of Functions for Controlling Reception Process System]

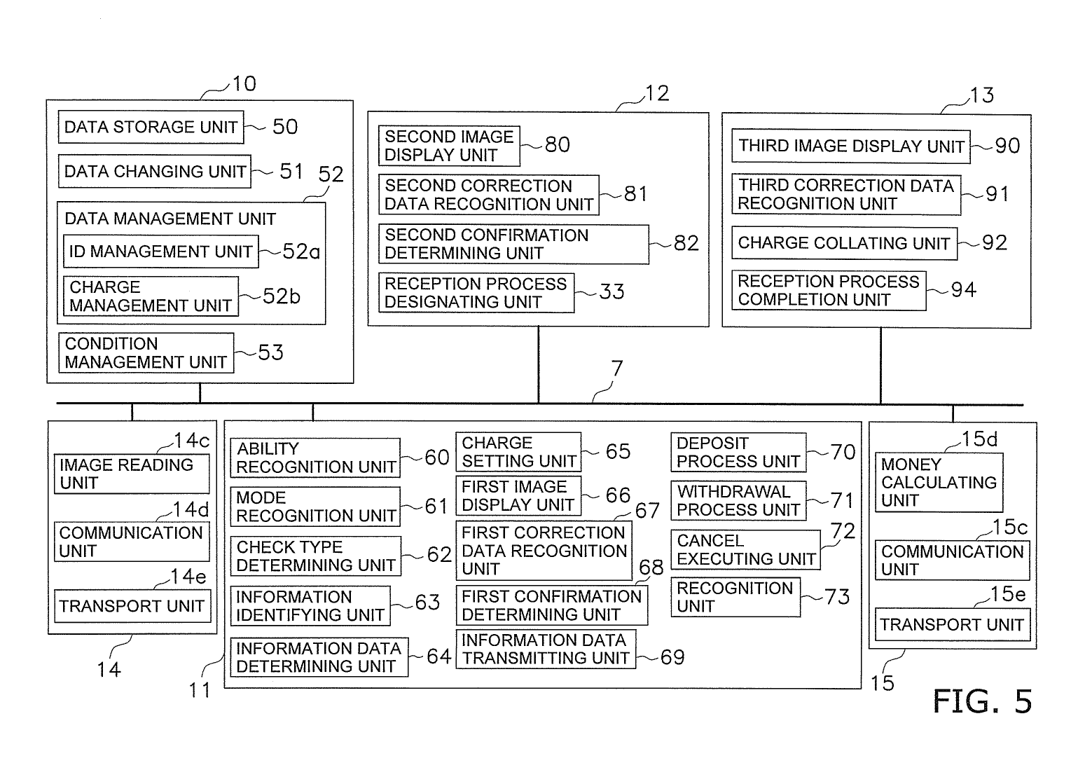

In the control of the reception process system for banks, functions which play main roles will be described with reference to FIG. 5.

### <Scanner>

In the scanner 14, for example, when a teller places an object to be read, such as a check or a slip, on a read table and pushes a read start button, the image reading unit 14c scans the object with the sensor and reads the object as image data. For example, when the object is a check, a surface image of the check is read as the check image data. Furthermore, when the object is a slip, a surface image of the slip is read as the slip image data. At this time, the scanner storage unit 14a records these image data. Then, the scanner communication unit 14d transmits the check image data and/or the image data for the slip from the scanner 14 to the server 10 and/or the other terminals 11, 12, and 13 in response to an instruction from the scanner control unit 14b. After the image reading unit 14c reads the object, the scanner transport unit 14e conveys the object from the read table to the escrow unit through the transportation mechanism, so as to store the object in the escrow unit. Upon obtaining the approval of the customer for the reception process, the object is conveyed by the transportation mechanism from the escrow unit to the storing unit and stored in the storing unit. Furthermore, the transportation mechanism operates based on an instruction of the scanner control unit 14b.

### <Server>

In the server 10, there exist a data storage unit 50 which stores data, a data changing unit 51 which changes data, a data management unit 52 which manages data, and a condition management unit 53

When the server 10 receives various data from the terminals 11, 12, and 13 through the server communication unit 10d, the data storage unit 50 executes process which stores these data. For example, when the server 10 receives image data, the data storage unit 50 executes process which stores the image data in the server storage unit 10a.

The data changing unit 51 changes various data recorded in the server storage unit 10a based on a data change signal. For example, in the server storage unit 10a, information data that defines a withdrawal bank name and an amount of money, and charge data that corresponds to the information data, are recorded. When the server 10 receives a data change signal from the terminals 11, 12, and 13 through the server communication unit 10d, the data changing unit 51 changes the information data and/or the charge data based on the data change signal. The server storage unit 10a stores the changed information data and/or the changed charge data. In this manner, the information data on the server 10 can be appropriately changed.

The data management unit 52 manages various data, such as basic data used in this system. The data management unit 52, for example, has an ID management unit 52a and a charge management unit 52b. The ID management unit 52a reads ID data of a teller and experience data of the teller from the server storage unit 10a in response to data reference requests from the terminals 11, 12, and 13. The ID management unit 52a transmits the ID data and/or the experience data of the teller to the terminals 11, 12, and 13 through the server communication unit 10d. The experience data is a data which is set as a predetermined value through an evaluation of the ability of the teller.

The charge management unit 52b reads the charge data from the server storage unit 10a in response to data reference requests from the terminals 11, 12, and 13. The charge management unit 52b transmits the ID data of the teller and/or the charge data to the terminals 11, 12, and 13 through the server communication unit 10d.

The condition management unit 53 manages condition data, which determines whether or not confirmation is necessary by a bank clerk at the back office. The condition management unit 53 reads the condition data from the server storage unit 10a in response to data reference requests from the terminals 11, 12, and 13. The condition management unit 53 transmits the condition data to the terminals 11, 12, and 13 through the server communication unit 10d.

### <Teller Terminal>

In the teller terminal 11, there exist an ability recognition unit 60, a mode recognition unit 61, a check type determining unit 62, an information identifying unit 63, an information data determining unit 64, a charge setting unit 65, a first image display unit 66, a first correction data recognition unit 67, a first confirmation determining unit 68, an information data transmitting unit 69, a deposit process unit 70, a withdrawal process unit 71, and a cancel executing unit 72.

The ability recognition unit 60 recognizes an ability level of a teller. For example, the ability recognition unit 60 recognizes the experience data of the teller recorded on the server 10 based on the ID data of the teller.

The mode recognition unit 61 recognizes a reception mode. The mode recognition unit 61 determines whether the reception process is a deposit process or a withdrawal process, and sets a mode based on the determination result. For example, when the teller performs the deposit process with a check or money, the mode recognition unit 61 recognizes the deposit mode for the check or money as the reception mode. In the withdrawal process performed by the teller, the mode recognition unit 61 recognizes the withdrawal mode as the reception mode.

Moreover, the mode recognition unit 61 determines a reception mode based on an input by the teller, for example, an input signal from the input unit 11e of the teller terminal. In this case, an example in which a reception mode is set by an input by the teller is described. However, the reception mode may be set in another manner. For example, the reception mode may be automatically set based on the information (slip information data) on a slip.

The check type determining unit 62 determines the type of a check based on check image data. For example, the check type determining unit 62 detects the size of the check based on the check image data, and determines whether the type of the check is a personal type or a business type.

The information identifying unit 63 identifies information on the check as check information data based on the check image data. More specifically, based on the type of the check, the information identifying unit 63 recognizes a format (position information of a check) for reading information on the check in the check image data. Based on the format, the information identifying unit 63 identifies the information on the check as the check information data.

The information identifying unit 63 identifies information of a slip as slip information data based on slip image data. More specifically, based on the format of the slip recorded in the storage unit 11a of the teller terminal, the information identifying unit 63 recognizes a position information of the slip for reading the information of the slip in the slip image data. The information identifying unit 63 then identifies the information of the slip as the slip information data based on the position information of the slip.

Specifically, the information identifying unit 63 identifies the check information data from the check image data and identifies the slip information data from the slip image data by using a pattern matching technique. More specifically, when a program for an OCR (Optical Character Reader) recorded in the storage unit 11a of the teller terminal is executed, a character pattern of the image data read by the scanner 14 and a character pattern recorded in the storage unit 11a are collated. In this manner, hand-written characters, printed characters, and the like on the check and/or the slip are extracted as character data from the image data read by the scanner 14. At this time, the character data is recorded in the storage unit 11a.

When information is manually designated by an input operation by the teller, the information identifying unit 63 identifies the information as information data. The information data includes, for example, at least one of the check information data and the slip information data.

The information data determining unit 64 determines, based on the check information data and the slip information data, whether the information on the check matches the information on the slip. At the same time, the information data determining unit 64 further determines, based on correction data (will be described later), whether the information on the check matches the information on the slip.

The charge setting unit 65 sets a bank charge for a check cashing, based on at least one of the check information data and the slip information data. More specifically, the charge setting unit 65 refers to information data to define a withdrawal bank name and an amount of money, and identifies a charge data corresponding to the information data. In this case, the information data that defines the withdrawal bank name and the amount of money corresponds to at least one of the check information data and the slip information data. Furthermore, a data table showing a corresponding relationship between charge data and information data that defines withdrawal bank names and amounts of money is stored in the server storage unit 10a of the server 10.

The first image display unit 66 displays various images and various pieces of information on the display of the teller terminal. For example, the first image display unit 66 displays information on a check and information on a slip based on the check information data and the slip information data. At the same time, the first image display unit 66 displays a check image and a slip image based on the check image data and the slip image data. Furthermore, the first image display unit 66 displays a notification on the display when the information on the check does not match the information on the slip. Moreover, when the information on the check and the information on the slip match each other, the first image display unit 66 displays a notification thereof on the display.

The first image display unit 66 displays a service charge and a withdrawal amount on the display. The withdrawal amount is calculated by subtracting the service charge from the amount of money written on the check. Furthermore, in the first correction data recognition unit 67 (will be described later), for example, when the teller designates a withdrawal bank name and/or an amount of money included in the information on the check with a keyboard and/or a mouse, the first image display unit 66 displays the designated information data and/or the designated amount of money on the display. Moreover, the first image display unit 66 displays a service charge and a withdrawal amount based on charge data and designated information data. The withdrawal amount is calculated by subtracting the service charge from the amount of money written on the check. The designed information data is data corresponding to the designated withdrawal bank name and/or the designed amount of money.

When the teller designates at least one of the information on the check and the information on the slip, the first correction data recognition unit 67 recognizes information data corresponding to the information designated by the teller as correction data. More specifically, when the teller designates, in the information on the check, a withdrawal bank name and/or an amount of money from a menu or the like by using a keyboard and/or a mouse, the first correction data recognition unit 67 recognizes predetermined information data included in the information on the check, for example, information data corresponding to the designated withdrawal bank name and/or the designated amount of money, as designated information data. In this case, as described above, the first image display unit 66 displays the designated withdrawal bank name and/or the designated amount of money on the display based on the designated information data. Furthermore, the correction data is recorded in the storage unit 11a of the teller terminal.

The first confirmation determining unit 68 determines whether or not a confirmation by a bank clerk (supervisor) is necessary, based on the check information data and the slip information data. The first confirmation determining unit 68 sets a flag in order to determine whether or not the confirmation by the supervisor is necessary based on at least one of the check information data and the slip information data. In this manner, whether or not the confirmation is necessary is determined. Furthermore, the first confirmation determining unit 68 determines the presence or absence of correction data. Moreover, the first confirmation determining unit 68 determines whether the ability level of the teller satisfies a predetermined ability level. The first confirmation determining unit 68 also determines whether or not a confirmation is directly requested through the keyboard and/or the mouse. Based on each determination result, the first confirmation determining unit 68 sets the flag.

The first confirmation determining unit 68 compares at least one of the check information data and the slip information data with the condition data. For example, at least one of the check information data and the slip information data includes amount data of the check, which shows the amount of money written on the check, and bank data of the check, which shows the bank name written on the check. In this case, the first confirmation determining unit 68 determines whether the amount data of the check is equal to or larger than the condition data, e.g. amount data representing a predetermined amount of money. Furthermore, the first confirmation determining unit 68 may determines whether the bank data of the check is the same as the condition data, e.g. bank data representing a bank of the teller. Moreover, the first confirmation determining unit 68 may determine whether the bank data of the check is the same as the condition data, e.g. bank data representing a predetermined bank. Based on each determination result, the first confirmation determining unit 68 sets the flag.

The information data transmitting unit 69 transmits at least one of the check information data and the slip information data to the supervisor terminal 12 through the communication unit 11d of the teller terminal. The information data transmitting unit 69 transmits the correction data and the flag to the supervisor terminal 12 through the communication unit 11d of the teller terminal. Furthermore, the information data transmitting unit 69 transmits at least one of the check image data and the slip image data to the supervisor terminal 12 through the communication unit 11d of the teller terminal.

The deposit process unit 70 executes a deposit process when at least one of the teller and the customer approves the information on the check.

The withdrawal process unit 71 executes a withdrawal process when at least one of the teller and the customer approves a withdrawal amount calculated by subtracting a service charge from the amount of money written on the check.

The cancel executing unit 72 cancels the reception process. For example, when a customer makes a request to cancel the reception process, the teller performs an operation to cancel the reception process and the cancel executing unit 72 cancels the reception process.

### <Supervisor Terminal>

In the supervisor terminal 12, there exist a second image display unit 80, a second correction data recognition unit 81, a second confirmation determining unit 82, and a reception process designating unit 83.

The second image display unit 80 displays various images and various pieces of information on the display of the supervisor terminal. For example, the second image display unit 80, based on the received image data, displays at least one of the image of the check and the image of the slip on the display.

The second image display unit 80, based on the check information data and the slip information data received from the teller terminal 11, displays the check information and the slip information. The second image display unit 80, based on each determination result obtained by the teller terminal 11, e.g. the flag received from the teller terminal 11, displays notifications of information necessary to be confirmed on the display based on each determination result obtained by the teller terminal 11, for example, the flag received from the teller terminal 11..

When the teller designates at least one of the check information and the slip information, the second correction data recognition unit 81 recognizes information data corresponding to the information designated by the teller as correction data. More specifically, when the supervisor designates, in the check information, a withdrawal bank name and/or an amount of money from the menu or the like by using the keyboard and/or the mouse, the second correction data recognition unit 81 recognizes predetermined information data included in the check information, for example, information data corresponding to the designated withdrawal bank name and/or the designated amount of money, as designated information data. At this time, as described above, the second image display unit 80, based on the designated information data, displays the designated withdrawal bank name and/or the designated amount of money on the display. The correction data is recorded in the storage unit 12a of the supervisor terminal.

The second confirmation determining unit 82, based on the check information data and the slip information data, determines whether a confirmation by a bank clerk (bank clerk in the center) is necessary. The second confirmation determining unit 82 determines the presence or absence of the correction data. More specifically, the second confirmation determining unit 82 determines the presence or absence of the correction data, and sets a flag depending on the presence or absence of the correction data.

The reception process designating unit 83 (i.e. the reception process completion unit in the supervisor terminal) completes the reception process when the supervisor confirms the check information, and designates the process corresponding to the reception process to the center. In this manner, the process in the supervisor terminal is completed. The reception process designating unit 83 transmits at least one of the check information data and the slip information data to the center terminal 13 through the communication unit 12d of the supervisor terminal when the supervisor confirms the check information. Furthermore, the reception process designating unit 83 transmits the correction data and the flag to the center terminal 13 through the communication unit 12d of the supervisor terminal. Moreover, the reception process designating unit 83 transmits at least one of the check image data and the slip image data to the center terminal 13 through the communication unit 12d of the supervisor terminal. In this manner, the process in the supervisor terminal is completed.

### <Center Terminal>

In the center terminal 13, there exist a third image display unit 90, a third correction data recognition unit 91, a check collating unit 92, and a reception process completion unit 94.

The third image display unit 90 displays various images and various pieces of information on the display. For example, the third image display unit 90 displays at least one of the check information and the slip information on the display based on the received image data. Furthermore, the third image display unit 90, based on the check information data and the slip information data received from the supervisor terminal 12, displays the check information and the slip information on the display.

Moreover, the third image display unit 90, based on the flag, displays notifications of information necessary to be confirmed on the display. Specifically, the third image display unit 90, based on each determination result obtained by the supervisor terminal 12, displays notifications of the information necessary to be confirmed on the display. More specifically, the third image display unit 90, based on the flag received from the supervisor terminal 12, displays notifications of the information necessary to be confirmed on the display.

When the supervisor corrects at least one of the check information and the check information, the third correction data recognition unit 91 recognizes the information data corresponding to the information corrected by the supervisor as correction data. At this time, the correction data is recorded in the storage unit 13a of the center terminal. In this case, the third image display unit 90, based on the correction data, displays the corrected information on the display.

The check collating unit 92 determines whether the check is legitimate. The check collating unit 92 downloads numbers on previously issued checks from the server 10 and determines whether the previously issued check numbers match the check number (included in the check information data) read by the scanner 14. When the numbers on the previously issued checks do not match the check number read by the scanner 14, the check collating unit 92 displays information representing that the check is legitimate on the display.

The reception process completion unit 94 completes the process in the center terminal when a bank clerk of the center confirms the reception processes of the teller and the supervisor. Specifically, after the bank clerk of the center confirms a correction item by the supervisor and collates the check, if the bank clerk of the center gives a final approval, the reception process completion unit 94 transmits the check information data, the slip information data, the check image data, and the slip image data to the server 10 through the communication unit 13d of the center terminal. In this manner, the process in the center terminal is completed, and final data is recorded on the server 10.

<Currency processing Device>

In the currency processing device 15, the money calculating unit 15d, the communication unit 15c, and the transport unit 15e of the currency processing device are controlled. The money calculating unit 15d controls a sorting mechanism and a calculating mechanism so as to calculate the number of banknotes and/or the number of coins and to calculate an amount of banknotes and/or an amount of coins. At this time, the amount of banknotes and/or the amount of coins are recorded in the storage unit 15a of the currency processing device as amount data of the banknotes and/or amount data of the coins.

The communication unit 15c of the currency processing device transmits various data, such as the amount data, from the currency processing device 15 to the server 10 and/or the other terminals 11, 12, and 13.

In a deposit state, the transport unit 15e of the currency processing device controls the convey mechanism. The transportation mechanism conveys the money from the money inlet, to the escrow unit, and to the deposit storing unit, in this order named. In a withdrawal state, the transport unit 15e of the currency processing device 15 controls the transportation mechanism. The transportation mechanism conveys the money from the withdrawal storing unit, to the escrow unit, and to the outlet, in this order.

### [Process of Controlling Reception Process System and Method Thereof]

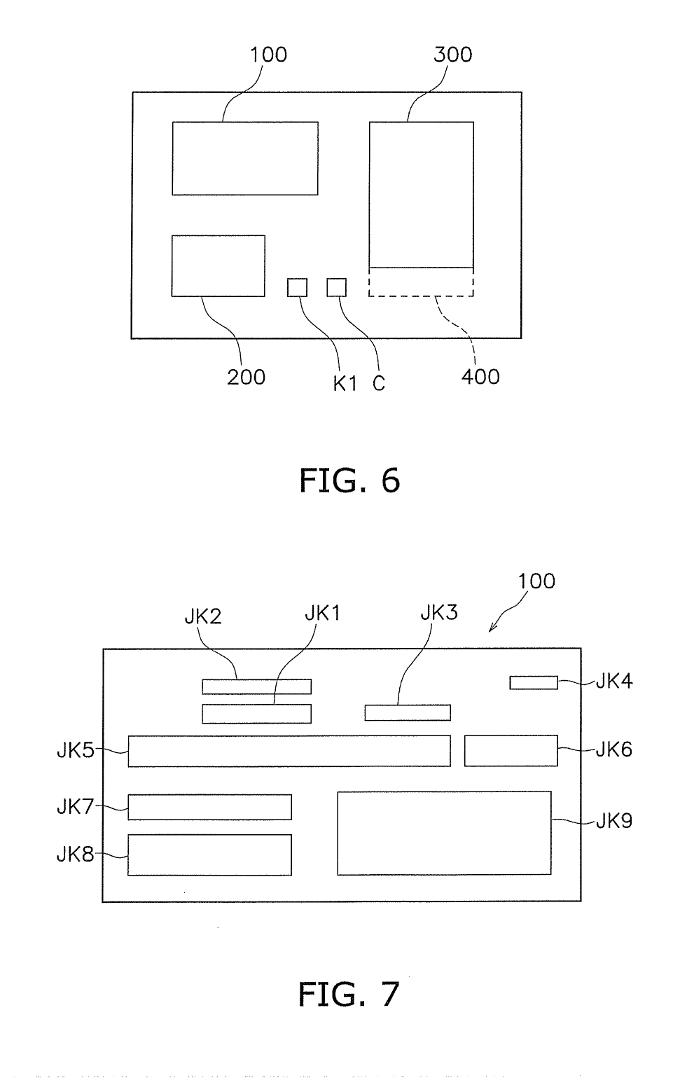

Here, processes of a reception process system of a bank and a control method thereof will be described below with reference to FIGS. 6 to 22. Various processes in the terminals 10 to 15, unless otherwise noted, are executed in the control units 10b to 15b of the terminals 10 to 15. Furthermore, records of various data in the terminals 10 to 15, unless otherwise noted, are recorded in the storage units 10a to 15a of the terminals 10 to 15. Moreover, various input processes in the terminals 10 to 13, unless otherwise noted, are performed through the input units 10e to 13e of the terminals 10 to 13.

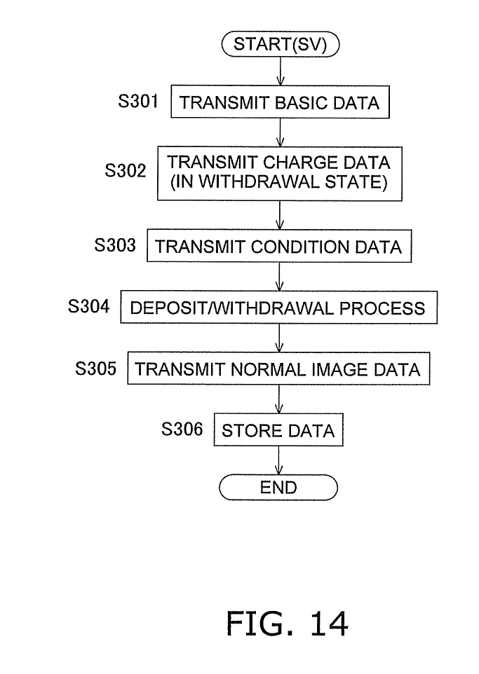

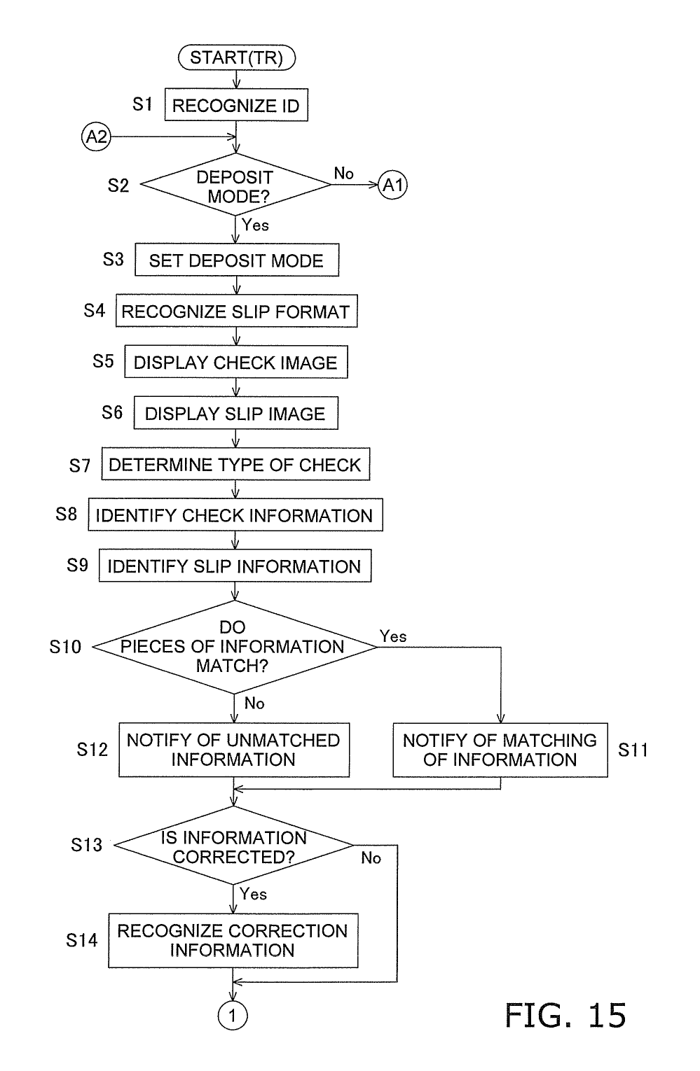

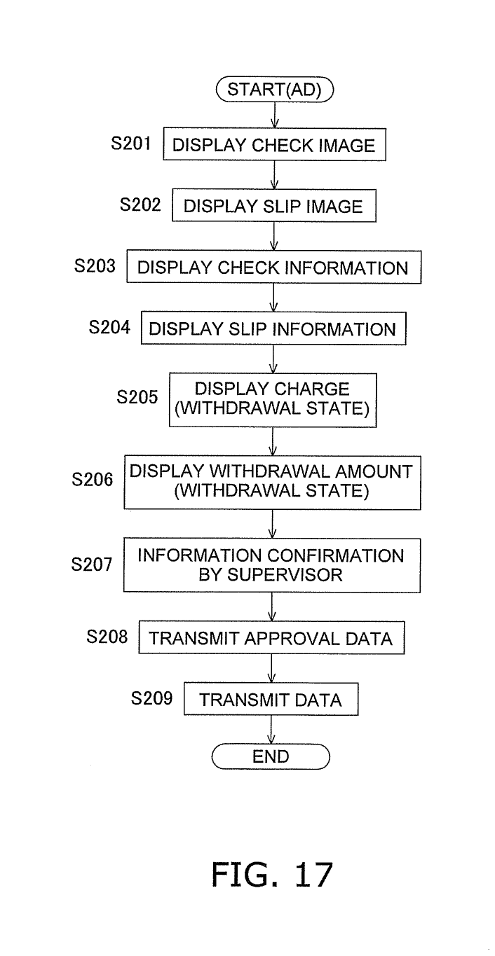

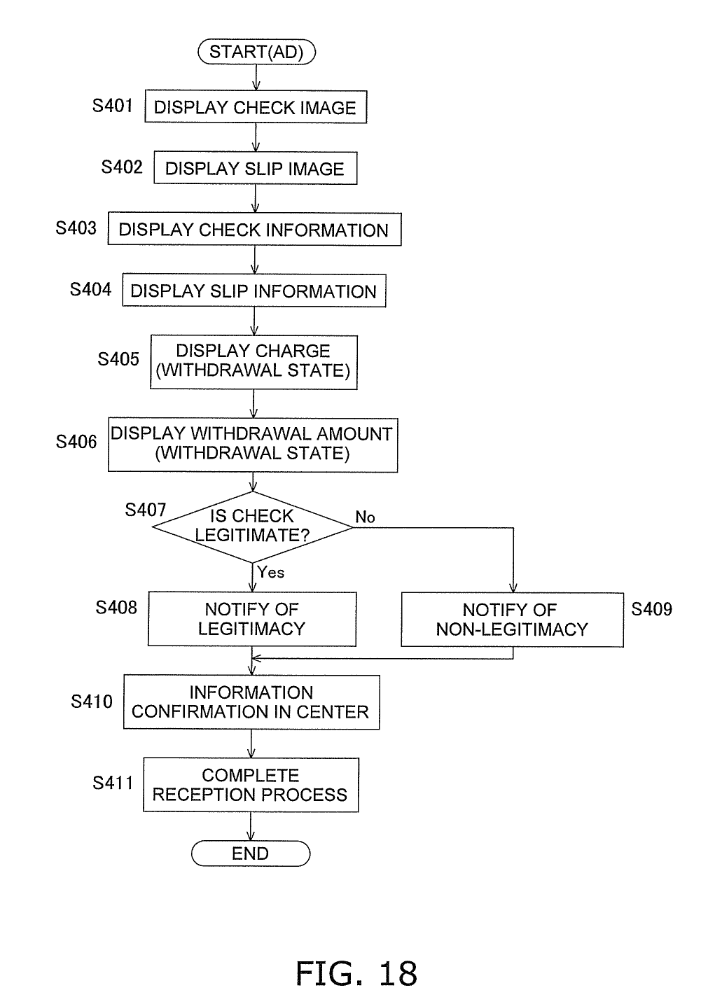

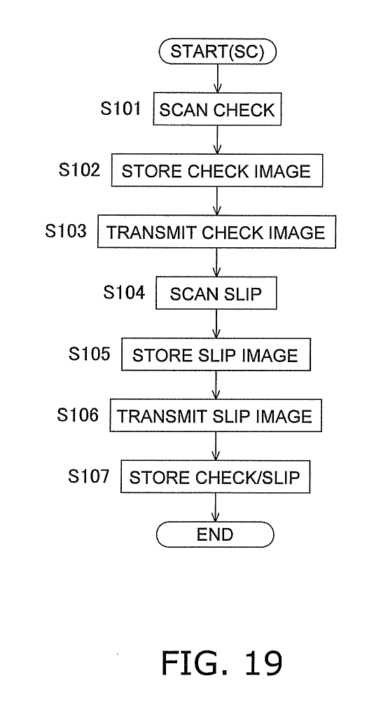

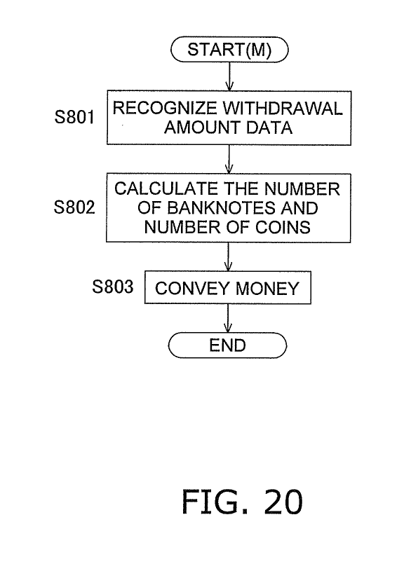

FIG. 14 shows an example of control flow in the server 10. FIGS. 15 and 16 and FIGS. 21 and 22 show an example of control flow in the teller terminal 11. FIG. 17 shows an example of control flow in the supervisor terminal 12. FIG. 18 shows an example of control flow in the center terminal 13. FIG. 19 shows an example of control flow in the scanner 14. FIG. 20 shows an example of control flow in the currency processing device 15.

When the teller inputs an ID number in the teller terminal 11, data corresponding to the ID number, i.e. ID data, is recognized and recorded (S1) in the teller terminal 11. At this time, a signal which requests transmission of various basic data is transmitted from the teller terminal 11 to the server 10. At this time, after the server 10 authenticates the ID data, the server 10 transmits the various basic data to the teller terminal 11 (S301; see FIG. 14). The basic data includes, for example, an experience data of the teller. In this case, the basic data is recorded in the storage unit 11a of the teller terminal.

When the teller receives a check and a slip from a customer, the teller selects a reception mode (S2). For example, when the teller selects a deposit icon or a withdrawal icon displayed on the display by using the keyboard and/or the mouse, the reception mode corresponding to the icon selected by the teller is selected. The reception mode is either one of a deposit mode and a withdrawal mode.

For example, when the teller selects the deposit icon (Yes in S2), the deposit mode is set (S3). On the other hand, when the teller selects the withdrawal icon (No in S2), the withdrawal mode is set (S503). For example, in the deposit mode (S3), a format of a deposit slip is set as the format of an object to be read (S4). In the withdrawal mode (No in S2, S503), a format of a withdrawal slip is set as the format of an object to be read (S504).

### <Deposit Mode>

When the deposit mode is selected (S3), the teller places a check in the scanner 14. A surface of the check is read by the scanner 14 (S101; see FIG. 19), and the check image is recorded as check image data (S102). The scanner 14 transmits the check image data to the teller terminal 11 (S103). The teller places a deposit slip in the scanner 14. At this time, a surface of the deposit slip is read by the scanner 14 (S104), and the image of the deposit slip is recorded as slip image data (S105). The scanner 14 transmits the slip image data to the teller terminal 11 (S106).

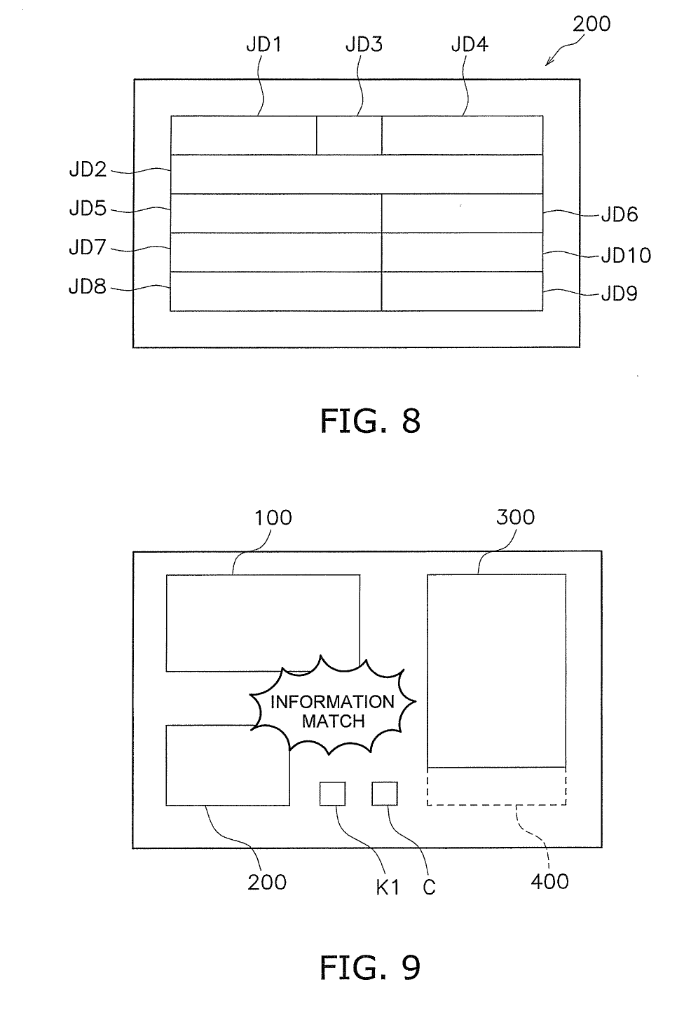

Subsequently, in the teller terminal 11, as shown in FIGS. 6 and 7, based on the check image data, a check image 100 is displayed on the display (S5). Also, in the teller terminal 11, as shown in FIGS. 6 and 8, based on the slip image data, a deposit slip image 200 is displayed on the display (S6).

Then, the teller terminal 11 determines the type of the check (S7). For example, based on the check image data received from the scanner 14, the size of the check is detected. More specifically, when the size of the check corresponds to the size of a personal check, the teller terminal determines that the check is a check of the personal type. The format of the personal type checks is then read from the storage unit 11a of the teller terminal. On the other hand, when the size of the check corresponds to the size of a business check the teller terminal determines that the check is a check of the business type. The format of the business type checks is then read from the storage unit 11a of the teller terminal.

Subsequently, based on the format of the check, position information on a check is recognized. The position information on the check includes position for reading information data from the check image. Based on the position information on the check, the item information on the check is then identified as the check information data (S8). Specifically, a program for OCR is executed. At this time, through a pattern matching technique, characters and/or numbers written on the check are identified as character data, and the character data is recorded.

As shown in FIG. 7, check item information JK includes a predetermined number of pieces of item information. For example, the check item information JK includes Account holder's name JK1, Account holder's address JK2, Date JK3 on which a check is written, Check number JK4, Payee JK5, Total amount JK6, Bank name JK7, Purpose of the check JK8, and Signature JK9 of the account holder.

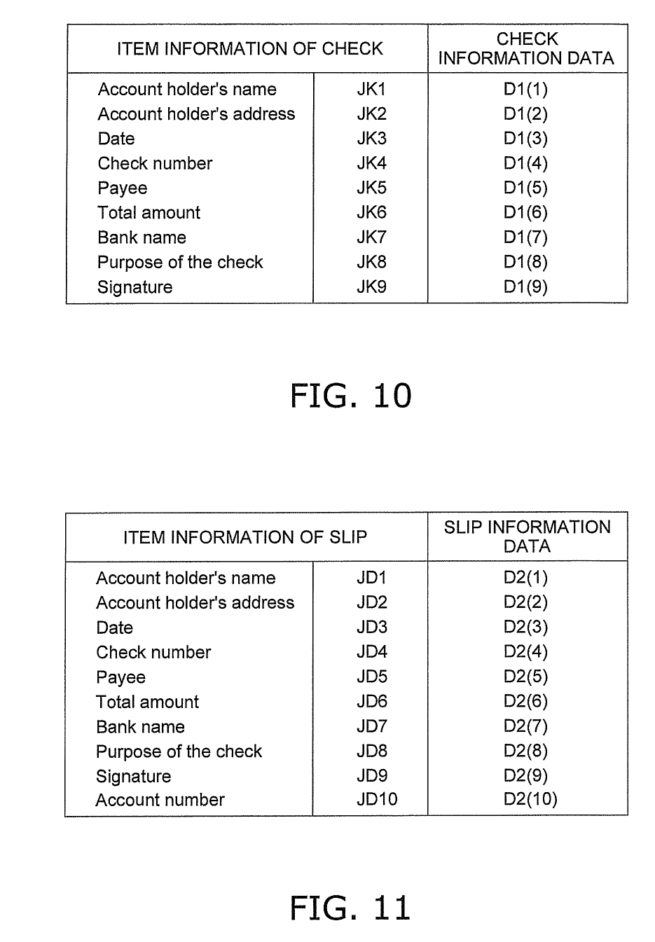

More specifically, as shown in FIG. 10, character data, each of which is constituted by characters and/or numbers of a different piece of information and corresponding to one of the check item information JK1 to JK9, are each assigned an information data, i.e. check information data D1(m). Note that reference symbol m denotes a natural number selected from 1 to 10. In this case, the check information data D1(10) is defined but not used.

Account holder's name JK1 is assigned to check information data D1(1). Account holder's address JK2 is assigned to check information data D1(2). Date JK3 on which the check is written is assigned to check information data D1(3). Check number JK4 is assigned to check information data D1(4). Payee JK5 is assigned to check information data D1(5). Total amount JK6 is assigned to check information data D1(6). Bank name JK7 is assigned to check information data D1(7). Purpose of the check JK8 is assigned to check information data D1(8). Signature JK9 is assigned to check information data D1(9).

The position information on the check is an information that defines positions of the item information JK1 to JK9. The position information on the check includes position coordinate data that defines the positions of the item information JK1 to JK9. Based on the position coordinate data, the positions of the item information JK1 to JK9 are specified, and the item information JK1 to JK9 are recognized as character data (or check information data D1(m)) representing the item information.

Based on the format of a deposit slip, position information on a slip is recognized. The position information on the slip includes position for reading information data from the slip image. At this time, based on the position information of the slip, the item information of the deposit slip is then identified as slip information data (S9). Specifically, a program for OCR is executed. At this time, through a pattern matching technique, characters and/or numbers written on the slip are identified as character data, and the character data is recorded.

As shown in FIG. 8, slip item information JD comprises a predetermined number of pieces of item information. For example, the slip item information JD includes Account holder's name JD1, Account holder's address JD2, Date JD3 on which a check is written, Check number JD4, Payee JD5, Total amount JD6, Bank name JD7, Purpose of the check JD8, Signature JD9 of the account holder, and Account number JD10.

In this case, as the slip item information JD, ten pieces of item information JD1 to JD10 are prepared. However, when a customer completes minimum amounts of information, the withdrawal process can be performed. For example, the minimum information includes Date JD3, Total amount JD6, Signature JD9 of an account holder, and Account number JD10.

More specifically, as shown in FIG. 11, character data, each of which is constituted by characters and/or numbers of a different piece of information and corresponding to one of the slip item information JD1 to JD10, are each assigned an information data, i.e. slip information data D2(m).

Account holder's name JD1 is assigned to slip information data D2(1). Account holder's address JD2 is assigned to slip information data D2(2). Date JD3 on which the check is written is assigned to slip information data D2(3). Check number JD4 is assigned to slip information data D2(4). Payee JD5 is assigned to slip information data D2(5). Total amount JD6 is assigned to slip information data D2(6). Bank name JD7 is assigned to slip information data D2(7). Purpose of the check JD8 is assigned to slip information data D2(8). Signature JD9 is assigned to slip information data D2(9). Account number JD10 is assigned to slip information data D2(10).

The position information of the slip is an information that defines positions of the item information JD1 to JD10. The position information of the slip includes position coordinate data that defines the positions of the item information JD1 to JD10. Based on the position coordinate data, the positions of the item information JD1 to JD10 are specified, and the item information JD1 to JD10 are recognized as character data (or slip information data D2(m)) representing the item information.

The above explanation is made based on a check of a personal type. However, even for a check of a business type, information data can be identified by the same processes as described above. A detailed explanation about the information data of a check of a business type is omitted.

As described above, after the information data is read from the check image data and the slip image data, the resolution of the check image data and the resolution of the slip image data may also be changed. For example, a resolution changing unit may be further arranged in the teller terminal to change the resolution of the check image data and the resolution of the slip image data depending on the amount of money written on the check. For example, the resolution changing unit may change the resolution of the check image data and the slip in a way such that the smaller the amount of money is written on a check, the smaller the resolution becomes. In this manner, since the data size of image data can decrease depending on the values of checks, transmission rate of the image data can be increased, and a ratio of the size of the image data to the capacity of the storage unit can be reduced.

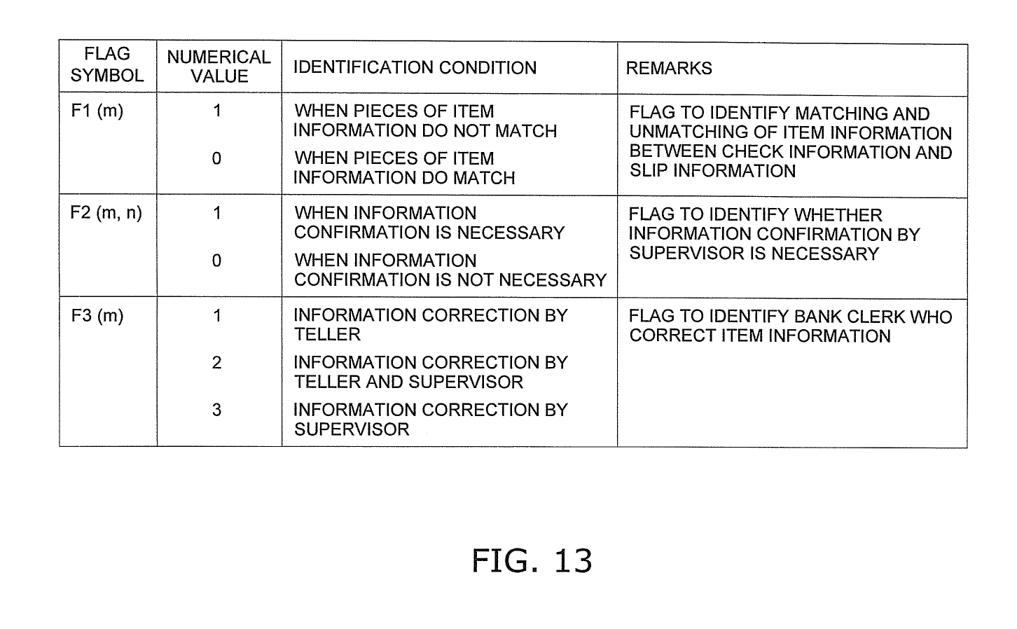

Subsequently, based the check information data D1(m) and the slip information data D2(m), it is determined whether the check item information JK1 to JK9 match the slip item information JD1 to JD9 (S10). In this case, a flag F1(m) identifies unmatched item information. For example, as shown in FIG. 13, when the item information do not match (No in S10), 1 is allocated to the flag F1(m). When the item information do match (Yes in S10), 0 is allocated to the flag F1(m). At this time, the flag F1(m) is recorded in the storage unit 11a of the teller terminal.

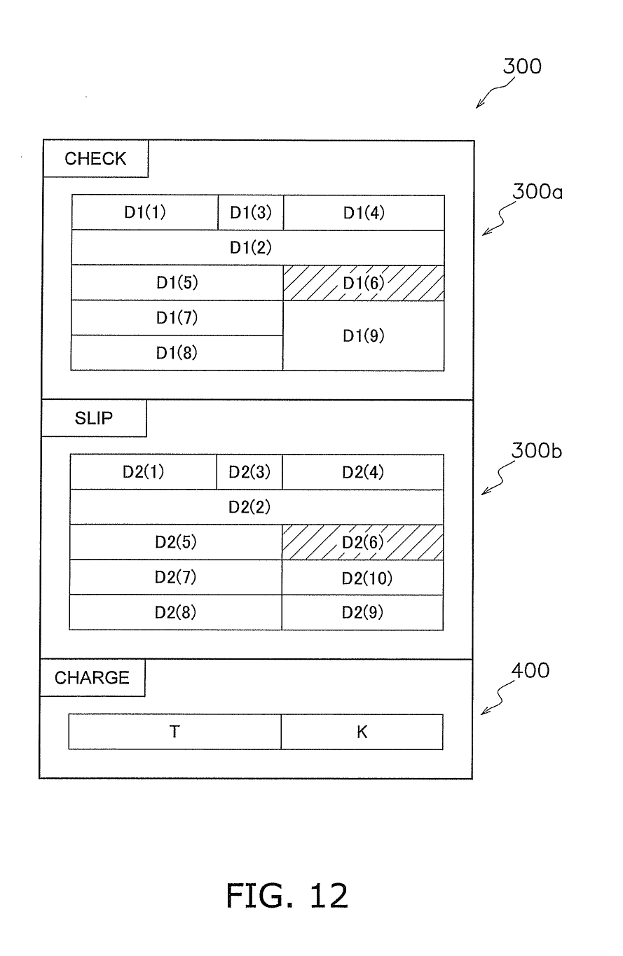

Subsequently, as shown in FIGS. 9 and 12, based on the check information data D1(m) and the slip information data D2(m), all of item information 300 of the check and the deposit slip are displayed on the display. In FIG. 12, a check item information column 300a is displayed on the upper side, and a withdrawal slip item information column 300b is displayed on the lower side. In FIG. 12, as the items on the check, the information corresponding to the check information data D1(m) are displayed. As the items on the slip, the information corresponding to the slip information data D2(m) are displayed. In this case, when all the information on the check match all the information on the deposit slip, as shown in FIG. 9, an image representing “matching information” is displayed on the display (S11).

On the other hand, when any of the information data D1(m) and D2(m) does not match (No in S10), the unmatched information data on the check and the deposit slip is reverse-displayed and/or highlighted. Specifically, by referring to the value of the flag F1(m), the check information data D1(m) in which the value of the flag F1(m) is 1 is recognized as a data corresponding to unmatched item information. Based on the unmatched information data, the unmatched item information is reverse-displayed and/or highlighted on the display (S12). For example, when the amount of money on the check does not match the amount of money on the deposit slip, the item of Total amount JK6 of the check and the item of Total amount JD6 of the deposit slip are reverse-displayed and/or highlighted (see a hatched portion in FIG. 12).

Subsequently, it is determined whether at least one of the check information data D1(m) and the slip information data D2(m) has been corrected by the teller (S13). For example, when the teller corrects at least one of the check information data D1(m) and the slip information data D2(m) (Yes in S13), information data corresponding to the information corrected by the teller is recognized as the correction data (S14). More specifically, in FIG. 12, when the teller corrects the information data D1(6) and D2(6) for the amount of money, the information data D1(6) and D2(6) corrected by the teller are recognized as the correction data, and the correction data are recorded in the storage unit 11a of the teller terminal.

In this case, a flag F3(m) that identifies the bank clerk who has corrected the information data D1(m) and D2(m) is set. For example, as shown in FIG. 13, when the teller has corrected at least one of the information data D1(m) and D2(m), 1 is allocated to the flag F3(m). When the flag F3(m) has been set like that, the person who has corrected the information data D1(m) and D2(m) can be specified/determined at a later time. For example, when the value of the flag F3(m) is found to be 1, the person who corrected the information data D1(m) and D2(m) would be identified as a teller. As will be described below, 2 or 3 may also be allocated to the flag F3(m). This will be explained in step 207 (S207) (will be described later).

In step 13 (S13), when it is determined that the teller has corrected at least one of the check information data D1(m) and the slip information data D2(m) (Yes in S13), the corrected information data is displayed again on the display. When the check information data D1(m) matches the slip information data D2(m), as described above, an image representing “matching information” is displayed on the display (see FIG. 9).

When the check information data D1(m) and the slip information data D2(m) are not corrected by the teller, the process in step 15 (S15) is executed.

Subsequently, the teller confirms, on the display, the check image 100 and the deposit slip image 200, the item information 300 of the check, and the item information 300 of the deposit slip (S15). When the teller uses the keyboard and/or the mouse to select a confirmation button K1 (see FIGS. 6 and 9) displayed on the display, whether an information confirmation by the supervisor is necessary or not is determined. At this time, information necessary to be confirmed by the supervisor is set (S16).

For example, based on at least one of the check information data D1(m) and the slip information data D2(m), whether an information confirmation by the supervisor is necessary or not is determined. In this case for example, as shown in FIG. 13, when it is determined that the confirmation by the supervisor is necessary, 1 is allocated to the flag F2(m, n). On the other hand, when it is determined that the information confirmation by the supervisor is not necessary, 0 is allocated to the flag F2(m, n). These flags F2(m, n) are recorded in the storage unit 11a of the teller terminal. Note that reference symbol n is a natural number selected from 1 to 6.

More specifically, the presence/absence of the correction data is determined. When the correction data is present, 1 is allocated to the flag F2(m, 1). When the correction data is absent, 0 is allocated to the flag F2(m, 1). In this manner, when the teller has manually corrected the information data, it is possible to notify the supervisor of the corrected portions.

Subsequently, it is determined whether the ability level of the teller is at a predetermined ability level. For example, it is determined whether the experience data of the teller is a predetermined value or more. When the experience data is smaller than the predetermined value, 1 is allocated to the flag F2(m, 2). When the experience data of the teller is the predetermined value or more, 0 is allocated to the flag F2(m, 2). This allocation is executed for all the flags F2(1, 2) to F2(9, 2). In this manner, when the skill of the teller is poor, the supervisor can be notified of the contents processed by the teller.

The experience data is a natural number selected from 1 to 10. The value of the experience data corresponds to the ability level of the teller. More specifically, when the ability of the teller increases, the value of the experience data increases. Furthermore, the value 3 is being used as the reference standard for determining the ability of the teller.

Subsequently, the teller uses the keyboard and/or the mouse to choose whether an information confirmation by the supervisor is directly requested. For example, when the teller desires the confirmation by the supervisor, 1 is allocated to the flag F2(m, 3). When the teller does not desire the confirmation by the supervisor, 0 is allocated to the flag F2(m, 3). This allocation is executed for all the flags F2(1, 3) to F2(9, 3). In this manner, when behavior of the customer seems strange the supervisor can confirm all the contents of the check.

A process of comparing at least one of the check information data D1(m) and the slip information data D2(m) with the condition data is executed. In this case, the condition data is transmitted from the server 10 to the teller terminal 11 (S303; see FIG. 14) and stored in the storage unit 11a of the teller terminal.

For example, it is determined whether the value of the check information data D1(6) representing the amount of money written on the check is the value of a predetermined amount data or more. When the value of the check information data D1(6) is the value of the predetermined amount data or more, 1 is allocated to flag F2(m, 4). On the other hand, when the value of the check information data D1(6) is smaller than the value of the predetermined amount data, 0 is allocated to the flag F2(m, 4). In this manner, when the amount of money written on the check is large, the supervisor can be notified of the amount of money.

Moreover, for example, it is determined whether the check information data D1(7) representing a withdrawal bank written on the check is the same as the bank data of the teller. When the check information data D1(7) is different from the bank data of the teller, 1 is allocated to the flag F2(m, 5). On the other hand, when the check information data D1(7) is the same as the bank data of the teller, 0 is allocated to the flag F2(m, 5). In this manner, when the withdrawal bank of the check is not the bank of the teller (her/his own bank), the supervisor can be notified of the bank name.

Moreover, for example, it is determined whether the check information data D1(7) representing the withdrawal bank written on the check is the same as a bank data included in a predetermined list. When the check information data D1(7) is the same as the bank data included in the predetermined list, 1 is allocated to the flag F2(m, 6). On the other hand, when the check information data D1(7) is different from the bank data included in the predetermined list, 0 is allocated to the flag F2(m, 6). In this manner, when the withdrawal bank of the check is a bank included in a predetermined list, such as a black list, the supervisor can be notified of the bank name.

The above process is executed to determine whether confirmation of information by the supervisor is necessary. For example, when the value of the flag F2(m, n) is 1, as will be described later, the supervisor is notified of the information which is necessary to be confirmed.

Subsequently, the customer or both the teller and the customer confirm the images and the information on the display (S17). It is determined whether or not the customer or both the teller and the customer approve the images and the information on the display (S18). When the customer or both the teller and the customer approve the images and the information on the display (Yes in S18), a deposit process is executed (S19). More specifically, in this case, when the teller selects, through the input unit such as the keyboard and/or the mouse, an approval button displayed on the display, the deposit process is executed.

When the deposit process is ended in the teller terminal 11, the teller terminal 11 sends the signal of the end of the deposit process to the scanner 14. At this time, the scanner 14 causes the transportation mechanism to move and the convey mechanism conveys the read check and the read deposit slip from the escrow unit to the deposit storing unit so as to be stored in the deposit storing unit (S107; see FIG. 19). When the deposit process is ended in the teller terminal 11, the teller terminal 11 also notifies the server 10 of the end of the deposit process. At this time, the server 10 deposits the amount of money written on the check into an account of the customer (S304; see FIG. 14).

Subsequently, various data are transmitted from the teller terminal 11 to the supervisor terminal 12 (S20). For example, the check information data D1(m) and the slip information data D2(m) are transmitted from the teller terminal 11 to the supervisor terminal 12. When the correction data is present, the check information data D1(m) and/or the slip information data D2(m) including the correction data are transmitted from the teller terminal 11 to the supervisor terminal 12. Furthermore, the flag F2(m, n) and the flag F3(m) are transmitted from the teller terminal 11 to the supervisor terminal 12. Moreover, the check image data and the slip image data are transmitted from the teller terminal 11 to the supervisor terminal 12.

On the other hand, when the customer or both the teller and the customer do not approve the item information on the check (No in S18), the process is cancelled (S21). Specifically, in this case, the teller uses the input unit, such as the keyboard and/or the mouse, to select a cancel button “C” displayed on the display. At this time, all the processes performed up to this step are canceled. For example, in the teller terminal 11, the check image data, the slip image data, the check information data D1(m), and the slip information data D2(m) are erased from the storage unit 11a of the teller terminal.

Subsequently, a deposit icon, a withdrawal icon, and an end icon that ends the reception process are displayed on the display (S22). In this case, for example, when the teller selects the end icon (Yes in S22), the process of the system ends. On the other hand, when the teller selects a continue icon (not shown) (No in S22), the process is re-executed from step 2 (S2).

Finally, a case in which the scanner 14 incorporates a reader for MICR will be briefly explained. In this case, the teller places a check in the scanner 14 so that the reader for MICR can read check information, i.e. information written on the check with magnetic-ink characters. In this case, the information read by the reader for MICR is compared with the check information data D1(m) so as to more reliably perform the reception process.

Next, control and processes in the supervisor terminal 12 will be described below.

After the work of the teller at the teller window ends, the supervisor starts working based on various data transmitted from the teller terminal 11 in the step 20 (S20) described above. For example, when the supervisor terminal 12 receives the various data transmitted from the teller terminal 11 in the step 20 (S20), in the supervisor terminal 12, the check image is displayed on the display based on the check image data (S201; see FIG. 17). Based on the slip image data, the image of the deposit slip is displayed on the display (S202). Furthermore, based on the check information data D1(m), the item information on the check is displayed on the display (S203). Moreover, based on the slip information data D2(m), the item information of the deposit slip is displayed on the display (S204).

In this case, the value of the flag F2(m, n) is referred to, and information data in which the value of the flag F2(m, n) is 1 is recognized as information data necessary to be confirmed by the supervisor. Then, the information necessary to be confirmed by the supervisor is reverse-displayed and/or highlighted on the display so that the supervisor may be notified Furthermore, the image and the information displayed on the display of the supervisor terminal 12 are the same as those shown in FIGS. 6, 9, and 12. For this reason, an explanation of the image and the information displayed on the display of the supervisor terminal 12 is made with reference to FIGS. 6, 9, and 12.

For example, in the step 13 (S13), when the teller corrects the information data D1(6) and D2(6) for the amount of money, as shown in FIG. 12, the item of Total amount JK6 of the check and Total amount JD6 of the deposit slip are reverse-displayed and/or highlighted (see hatched portions in FIG. 12). Furthermore, when a teller whose skill is poor performs the reception process at the teller window, and/or when a teller requests an information confirmation by the supervisor, all the items are reverse-displayed and/or highlighted. Moreover, when the amount of money of a check is large, Total amount JK6 of the check and Total amount JD6 of the deposit slip are reverse-displayed and/or highlighted (see hatched portions in FIG. 12). Moreover, when a withdrawal bank of a check is not the bank at which the reception process is performed, and/or when the withdrawal bank of the check is a bank included in a predetermined list, such as a black list, the item of Bank name JK7 of the check and the item of the Bank name JD7 of the deposit slip are reverse-displayed and/or highlighted.

Subsequently, the supervisor, on the display, confirms the check image 100, the deposit slip image 200, the item information 300 of the check, and the item information 300 of the deposit slip (S207). In this case, when the supervisor uses the keyboard and/or the mouse to correct at least one of the information data D1(m) and D2(m) displayed on the display, the corrected information data is recognized as new correction data. The new correction data is recorded in the storage unit 12a of the supervisor terminal. In this case, 1 is allocated to the flag F2(m, 1). In this manner, when the supervisor has manually corrected the information data, a bank clerk of the center can be notified of the corrected portions.

In this case, the flag F3(m) is also set. For example, as shown in FIG. 13, when the supervisor corrects at least one of the information data D1(m) and D2(m), 2 or 3 is allocated to the flag F3(m). More specifically, when the supervisor further corrects the information data D1(m) and D2(m) corrected by the teller already, 2 is allocated to the flag F3(m). On the other hand, when the information data D1(m) and D2(m) which have not been corrected by the teller are corrected by the supervisor, 3 is allocated to the flag F3(m).

When the flag F3(m) has been set like that, the person who has corrected the information data D1(m) and D2(m) can be specified/determined at a later time. For example, when the value of the flag F3(m) is found to be 1, the person who corrected the information data D1(m) and D2(m) is identified as a teller. When the value of the flag F3(m) is 2, the person who corrected the information data D1(m) and D2(m) is identified as both the teller and a supervisor. Furthermore, when the value of the flag F3(m) is 3, the person who corrected the information data D1(m) and D2(m) is identified as the supervisor.

Subsequently, when the supervisor uses the keyboard and/or the mouse to select a confirmation button “K1” displayed on the display, approval data is recorded on the supervisor terminal 12. In this manner, the information is confirmed by the supervisor (S207). The approval data is then transmitted from the supervisor terminal 12 to the center terminal 13 at a predetermined time (S208).

Subsequently, various data are transmitted from the supervisor terminal 12 to the center terminal 13 (S209). For example, the check information data D1(m) and the slip information data D2(m) are transmitted from the supervisor terminal 12 to the center terminal 13. In the presence of the correction data, the check information data D1(m) and/or the slip information data D2(m) including the correction data is transmitted from the supervisor terminal 12 to the center terminal 13. Furthermore, the flag F2(m, n) and the flag F3(m) are transmitted from the supervisor terminal 12 to the center terminal 13. Moreover, the check image data and the slip image data are transmitted from the supervisor terminal 12 to the center terminal 13.

Finally, control and processes in the center terminal 13 will be explained.

When the center terminal 13 receives various data from the supervisor terminal 12 in the step 209 (S209), in the center terminal 13, based on the check image data and the slip image data, the check image and the deposit slip image are displayed (S401, S402; see FIG. 18). Based on the check information data D1(m) and the slip information data D2(m), the item information on the check and the item information of the deposit slip are displayed on the display (S403, S404).

In this case, the value of the flag F2(m, n) is referred to, and the presence/absence of information data necessary to be confirmed by a bank clerk of a control center is determined. When the information confirmation by the bank clerk of the control center is necessary, i.e. when information data in which the flag F2(m, n) is 1 is present, based on the information data, the information necessary to be confirmed by the bank clerk of the control center is reverse-displayed and/or highlighted on the display so that the bank clerk of the center can be notified.

Specifically, the information of which the supervisor is notified is displayed in, for example, red, and the information corrected by the supervisor is displayed in, for example, blue. In this case, when the bank clerk of the center corrects the information, the information corrected by the clerk of the center is displayed in, for example, green. In this manner, the clerk of the center can easily recognize the items he/she needs to confirm and the items he/she has corrected while understanding the items confirmed by the supervisor. The case in which the information of which the supervisor is notified, the information corrected by the supervisor, and the information corrected by the bank clerk of the center are displayed in different colors is explained here. However, it may also be acceptable if only the information corrected by the supervisor is displayed in a different color. In this case, the bank clerk of the center can reliably understand at least the items which must be confirmed by herself/himself.

Since the image and the information displayed on the display of the center terminal 13 are the same as those shown in FIGS. 6, 9, and 12, a detailed explanation about the information notification performed here will not be made.

Subsequently, it is determined whether the check is legitimate (S407). For example, check numbers previously issued in the past are transmitted from the server 10 to the center terminal 13 (S305; see FIG. 14) and stored in the storage unit 13a of the center terminal. It is determined whether the previously issued check numbers match the check information data D1(4) corresponding to the check number read by the scanner 14. When the numbers (the previously issued check number and the check number read by the scanner 14) match each other (No in S407), an information representing that the check is illegitimate, e.g. characters “illegitimate”, is displayed on the display like the information shown in FIG. 9 (S409). On the other hand, when the check numbers do not match each other (Yes in S407), an information representing that the check is legitimate, e.g. characters “legitimate” is displayed on the display in place of the information shown in FIG. 9 (S408).

Subsequently, the bank clerk of the center confirms, on the display, the check image 100, the deposit slip image 200, the item information 300 of the check, and the item information 300 of the deposit slip. When the bank clerk of the center approves the reception processes of the teller and the supervisor (S410), the process in the center terminal 13 is completed (S411). Specifically, when the bank clerk of the center uses the keyboard and/or the mouse to select the confirmation button “K1” displayed on the display, various data are transmitted from the center terminal 13 to the server 10. In this case, the check information data and the slip information data, the image check data, and the slip image data are transmitted to the server 10 through the communication unit 13d of the center terminal. In this manner, the process in the center terminal 13 is completed, and final data is recorded in the server storage unit 10a (S306; see FIG. 14).

In this manner, in the center terminal 13, since only necessary portions need to be confirmed, the time required for processing in the center can be considerably reduced.

### <Withdrawal Mode>

When a withdrawal mode is selected (No in S2), in the teller terminal 11, the withdrawal mode is set (S503), and a format of a withdrawal slip is set as the format of an object to be read (S504). When the teller places a check in the scanner 14, a surface of the check is read by the scanner 14 (S101; see FIG. 19), and the check image is recorded as check image data (S102). The scanner 14 transmits the check image data to the teller terminal 11 (S103). The teller then places the withdrawal slip in the scanner 14. A surface of the withdrawal slip is read by the scanner 14 (S104), and the image of the withdrawal slip is recorded as the slip image data (S105). At this time, the scanner 14 transmits the slip image data to the teller terminal 11 (S106).

A detailed explanation about the same processes as those in the deposit mode and the methods thereof will not be made, and only an outline will be explained. For example, it is possible to replace the term “deposit” in the deposit mode with the term “withdrawal” and use the explanation in the deposit mode as an explanation of the withdrawal mode.

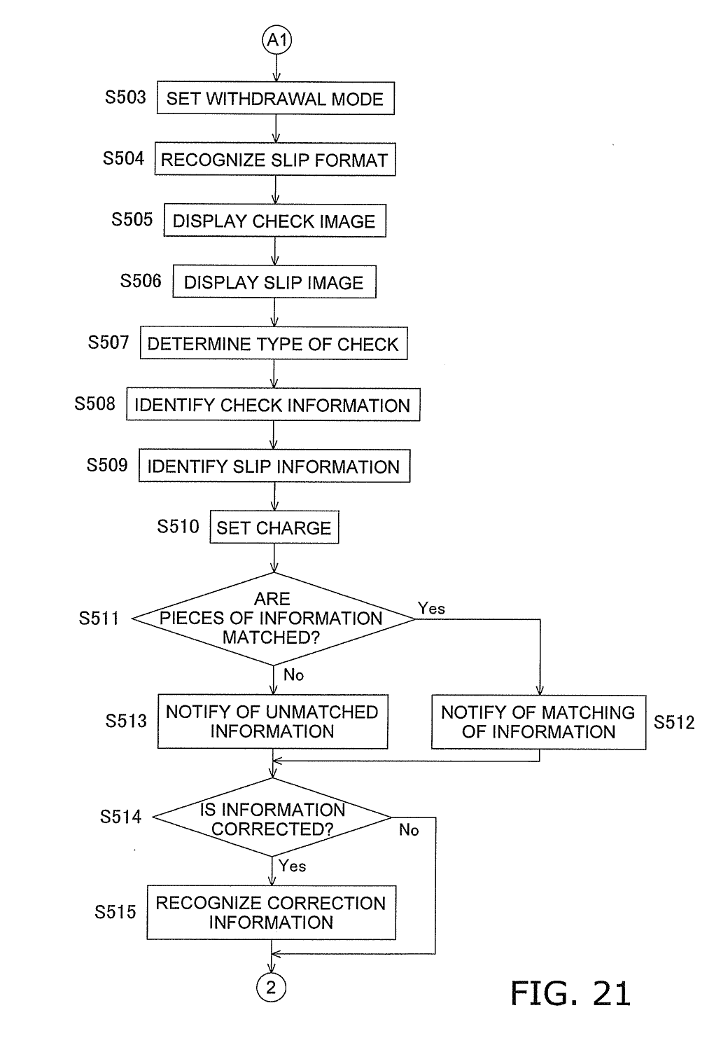

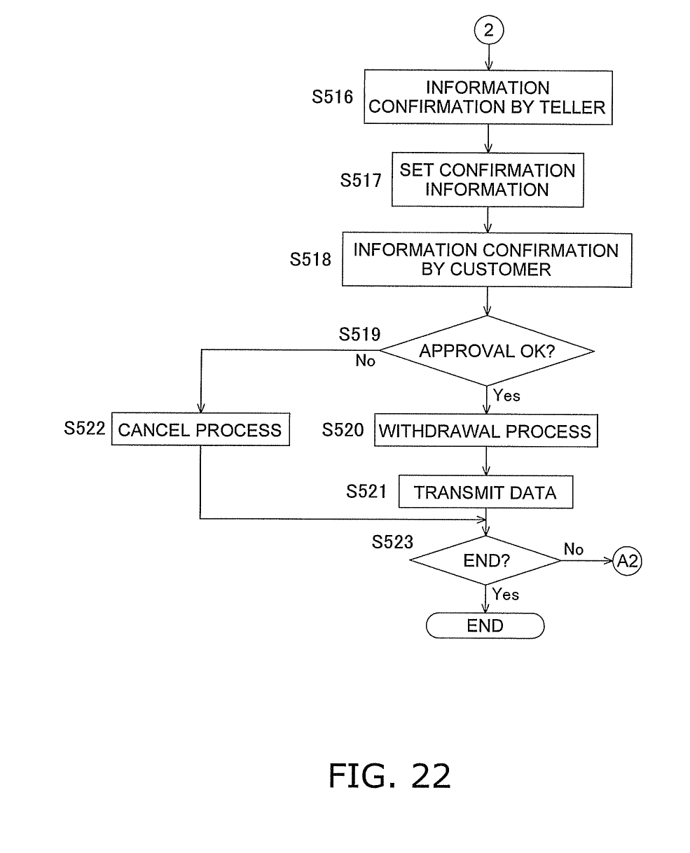

Control and processes in the teller terminal 11 will be mainly described below with reference to FIGS. 21 and 22.

In the teller terminal 11, as shown in FIGS. 6 and 7, based on the check image data, the check image 100 is displayed on the display (S505). In the teller terminal 11, as shown in FIGS. 6 and 8, based on the slip image data, the image of the withdrawal slip is displayed on the display (S506).

Subsequently, in the teller terminal 11, the type of the check is determined (S507). For example, in the teller terminal 11, it is determined whether the type of the check is a personal type or a business type. The format corresponding to the type of the check, for example, the format of the personal type checks or the format of the business type checks is then read from the storage unit 11a of the teller terminal.

Subsequently, as shown in FIG. 7, based on the format of the check, a position (position information on the check) where the check information data D1(m) is to be read from the check image data is recognized. As shown in FIG. 10, based on the position information on the check, the item information on the check is then identified as the check information data D1(m) (S508). For this identification, for example, a program for OCR is used.

Subsequently, based on the format of the withdrawal slip as shown in FIG. 8, a position (position information of the slip) where the slip information data D2(m) is to be read from the slip image data is recognized. Based on the position information of the slip, the item information of the slip as shown in FIG. 11 is then identified as the slip information data D2(m) (S509). For this identification, for example, a program for OCR is used.

Subsequently, based on at least one of the check information data D1(m) and the slip information data D2(m), a bank charge for cashing the check is set (S510). In particular, at least one data within the check information data D1(m) and the slip information data D2(m) is recognized, and a charge data T corresponding to the recognized data is identified.

For example, as shown in FIGS. 10 and 11, the check information data D1(6) and D1(7) corresponding to the amount of money and the withdrawal bank name written on the check or the slip information data D2(6) and D2(7) corresponding to the amount of money and the withdrawal bank name written on the withdrawal slip may be recognized.

A case using the check information data D1(6) and D1(7) corresponding to the amount of money and the withdrawal bank name written on the check will be explained as an example. When the check information data D1(6) and D1(7) are recognized, a request for referring to the charge data T corresponding to the check information data D1(6) and D1(7) is transmitted from the teller terminal 11 to the server 10. In response to this request, the server 10 transmits the charge data T to the teller terminal 11 (S302; see FIG. 14). At this time, the charge data T is recorded in the storage unit 11a of the teller terminal.

Subsequently, based on the check information data D1(m) and the slip information data D2(m), it is determined whether the item information JK1 to JK9 of the check and the item information JD1 to JD9 of the withdrawal slip match each other (S511). When the item information JK1 to JK9 of the check and the item information JD1 to JD9 of the withdrawal slip do not match each other, a flag F1(m) that identifies unmatched item information is set.

Subsequently, as shown in FIG. 12, based on the check information data D1(m) and the slip information data D2(m), all of item information 300 of the check and the withdrawal slip are displayed on the display. In FIG. 12, a check item information column 300a is displayed on the upper side, and a withdrawal slip item information column 300b is displayed on the lower side. As items on the check, the information corresponding to the check information data D1(m) are displayed. As items on the withdrawal slip, the information corresponding to the slip information data D2(m) is displayed. In this case, when all the item information on the check match all the item information on the withdrawal slip, as shown in FIG. 9, an image representing “matching information” is displayed on the display (S512). A paying-out amount data K is calculated based on the charge data T. For example, the paying-out amount data K is calculated by subtracting the charge from the amount of money written on the check (K=D1(6)−T). The charge and the withdrawal amount are then displayed on the display (see FIG. 12).

On the other hand, when any of the information data D1(m) and D2(m) does not match (No in S511), based on the flag F1(m), the unmatched item information on the check and the withdrawal slip is reverse-displayed and/or highlighted (S512). In FIG. 12, as an example, the item of Total amount JK6 of the check and the item of the Total amount JD6 of the withdrawal slip are reverse-displayed and/or highlighted.

When a withdrawal bank name is not included in the list of the server 10, reverse display and/or highlighting are performed without displaying numerical values for the item of the charge data T and the item of the withdrawal amount data K calculated by subtracting the charge from the amount of money written on the check.

It is determined whether at least one of the check information data D1(m), the item information data D2(m) of the withdrawal slip, and the charge data T has been corrected by the teller (S514). For example, when the teller corrects at least one of the check information data D1(m), the item information D2(m) of the withdrawal slip, and the charge data T through the keyboard and/or the mouse (Yes in S514), the information data corrected by the teller is recognized as the correction data (S515). Also, when the teller assigns a predetermined amount of money to the item of the charge data T through the keyboard and/or the mouse (Yes in S514), information data representing the input amount of money is recognized as the correction data (S515).

Furthermore, when the teller has corrected at least one of the check information data D1(m), the item information D2(m) of the withdrawal slip, and the charge data T, the information corrected by the teller is displayed again on the display based on the correction data. When the check information data D1(m) matches the slip information data D2(m), as described above, an image representing “matching information” is displayed on the display.

Moreover, when the teller has directly assigned the charge data T, the charge data T input by the teller is displayed again on the display based on the correction data. The withdrawal amount data K, calculated by subtracting the charge input by the teller from the amount of money written on the check, is also displayed again on the display. For example, when a withdrawal bank name is not included in the list of the server 10 and the teller directly assigns the predetermined charge data T, the withdrawal amount data K, calculated by subtracting the charge input by the teller from the amount of money written on the check, is displayed again on the display. When the predetermined charge data T is input, the display of the items is changed from the reverse-displayed and/or highlighted style back to the normal style.

When no data has been corrected by the teller, the process in step 516 (S516) is executed.

Subsequently, on the display, the teller confirms the check image 100, the withdrawal slip image 200, the item information 300 of the check, the item information 300 of the withdrawal slip, and charge and withdrawal amount 400 (S516). When the teller uses the keyboard/mouse to select the confirmation button K1 (see FIGS. 6 and 9) displayed on the display, whether an information confirmation by the supervisor is necessary or not is determined and information which is necessary to be confirmed by the supervisor is set (S517).

For example, based on at least one of the check information data D1(m) and the slip information data D2(m), whether or not the confirmation by the supervisor is necessary is determined. When it is determined that the information confirmation by the supervisor is necessary, a flag F2(m, n) is set to 1. Reference symbol m denotes a natural number selected from 1 to 10, and reference symbol n denotes a natural number selected from 1 to 6. For example, when it is determined that the confirmation by the supervisor is necessary, 1 is allocated to the flag F2(m, n). On the other hand, when it is determined that the information confirmation by the supervisor is not necessary, 0 is allocated to the flag F2(m, n). These flags 2(m, n) are recorded in the storage unit 11a of the teller terminal.

For example, in the presence of the correction data for a service charge, 1 is allocated to the flag F2(10, 1). In the absence of such a correction data, 0 is allocated to the flag F2(10, 1). In this manner, when the teller has manually assigned the charge data T, the supervisor can be notified of the corrected portion. Since the setting of the other flags F2(m, n) is the same as that in the deposit mode, an explanation thereof will not be made.

Based on the above executed processes, whether or not the information confirmation by the supervisor is necessary is determined. For example, when a value of the flag F2(m, n) is 1, as will be described later, the supervisor is notified of the information which is necessary to be confirmed.

The customer or both the teller and the customer confirm the images and the information on the display (S518). It is determined whether the customer or both the teller and the customer approve the images and the information on the display (S519). When the customer or both the teller and the customer approve the images and the information on the display (Yes in S519), a withdrawal process is executed (S520). Specifically, in this case, when the teller selects, through the input unit such as the keyboard and/or the mouse, an approval button displayed on the display, the withdrawal process is executed.

When the withdrawal process is ended in the teller terminal 11, the teller terminal 11 notifies the scanner 14 of the end of the withdrawal process. The scanner 14 causes the transportation mechanism to move and the transportation mechanism conveys the read check and the read withdrawal slip from the escrow unit to the storing unit so as to be stored in the storing unit (S107; see FIG. 19). When the withdrawal process ends in the teller terminal 11, the teller terminal 11 also notifies the server 10 of the end of the withdrawal process. The server 10 executes the process of paying the amount of money from which the charge has been subtracted, from a drawing account (S304; see FIG. 14).

Furthermore, when the withdrawal process ends in the teller terminal 11, the teller terminal 11 also notifies the currency processing device 15 of the end of the withdrawal process. The teller terminal 11 also transmits amount data to the currency processing device 15. At this time, the currency processing device 15 executes the process of paying the amount of money, from which the charge has been subtracted, from the drawing account. For example, in the currency processing device 15, the withdrawal amount data K received from the teller terminal 11 is recognized (S801; see FIG. 20). Money (banknotes, coins) is calculated in the money calculating unit 15d on the basis of the withdrawal amount data K. Money (banknotes, coins) corresponds to the amount of money which is calculated by subtracting the charge from the amount of money written in the check. Money (banknotes, coins) is stored in an escrow unit (S802). Banknotes and coins counted in the money calculating unit 15d are conveyed from the escrow unit to the outlet (S803). The customer then receives the money from the outlet.

On the other hand, when the customer or both the teller and the customer do not approve the item information on the check (No, in S519), the process is cancelled (S522). In this case, in the teller terminal 11, the check image data, the slip image data, the check information data D1(m), the slip information data D2(m), and the charge data T are erased from the storage unit 11a of the teller terminal.

After the withdrawal process, various data are transmitted from the teller terminal 11 to the supervisor terminal 12 (S521). For example, the check information data D1(m), the slip information data D2(m), and the charge data T are transmitted from the teller terminal 11 to the supervisor terminal 12. In the presence of the correction data, the check information data D1(m) and/or the slip information data D2(m) including the correction data, the charge data T including the correction data, and the charge-subtracted withdrawal amount data K are transmitted from the teller terminal 11 to the supervisor terminal 12. The flag F2(m, n) is also transmitted from the teller terminal 11 to the supervisor terminal 12. Furthermore, the check image data and the slip image data are transmitted from the teller terminal 11 to the supervisor terminal 12.

Subsequently, a deposit icon, a withdrawal icon, and an end icon that ends the reception process are displayed on the display (S523). In this case, for example, when the teller selects the end icon (Yes in S523), the process of the system ends. On the other hand, when the teller selects a continue icon (No in S523), the process is re-executed from step 2 (S2).

Finally, a case in which the scanner 14 incorporates a reader for MICR will be briefly explained. In this case, the teller places a check in the scanner 14 so that the reader for MICR can read check information, i.e. information written on the check with magnetic-ink characters. In this case, the information read by the reader for MICR is compared with the check information data D1(m) so as to more reliably perform the reception process.

Then, control and processes in the supervisor terminal 12 will be described below.

After the work of the teller at the teller window ends, the supervisor starts working based on the various data transmitted from the teller terminal 11 in the step 20 (S20) described above. For example, when the supervisor terminal 12 receives the various data transmitted from the teller terminal 11 in the step 521 (S521), in the supervisor terminal 12, the check image, the withdrawal slip image, the item information on the check, and the item information of the withdrawal slip are displayed on the display (S201, S202, S203, S204; see FIG. 17).

Based on the charge data T, the service charge is displayed on the display (S205). Based on the charge-subtracted withdrawal amount data K, the withdrawal amount from which the charge has been subtracted is displayed on the display (S206). Furthermore, based on the flag F2(m, n), information necessary to be confirmed by the supervisor is reverse-displayed and/or highlighted on the display. The image and the information displayed on the supervisor terminal 12 are the same as those shown in FIGS. 6, 9, and 12.

Subsequently, the supervisor confirms the check image 100, the deposit slip image 200, the item information 300 of the check, and the item information 300 of the deposit slip (S207). When the supervisor uses the keyboard and/or the mouse to correct at least one of the information data D1(m) and D2(m) and the charge data T displayed on the display, these corrected data are recognized as the new correction data, and the new correction data is recorded in the storage unit 12a of the supervisor terminal. In this case, 1 is allocated to the flag F2(m, 1) and/or F2(10, 1). In this manner, when the supervisor has manually corrected the information data, the bank clerk of the center can be notified of the corrected portions based on the flag F2(m, 1) and/or F2(10, 1).

When the supervisor uses the keyboard and/or the mouse to select the confirmation button K1 displayed on the display, approval data is recorded on the supervisor terminal 12. In this manner, the information is confirmed by the supervisor (S207). The approval data is then transmitted from the supervisor terminal 12 to the center terminal 13 at a predetermined time (S208).

Subsequently, various data are transmitted from the supervisor terminal 12 to the center terminal 13 (S209). For example, the check information data D1(m), the slip information data D2(m), and the charge data T are transmitted from the supervisor terminal 12 to the center terminal 13. In the presence of the correction data, the check information data D1(m) and/or the slip information data D2(m) including the correction data, the charge data T including the correction data, and the charge-subtracted withdrawal amount data K are transmitted from the supervisor terminal 12 to the center terminal 13. The flag F2(m, n) is also transmitted from the supervisor terminal 12 to the center terminal 13. Furthermore, the check image data and the slip image data are transmitted from the supervisor terminal 12 to the center terminal 13.

Finally, control and processes in the center terminal 13 will be explained.

When the center terminal 13 receives various data from the supervisor terminal 12 in the step 209 (S209), in the center terminal 13, the image of the check and the image of the deposit slip, the item information on the check, and the item information of the deposit slip are displayed on the display of the center terminal 13 (S401, S402, S403, S404; see FIG. 18).

Based on the charge data T, the service charge is displayed on the display (S205). Based on the charge-subtracted withdrawal amount data K, the withdrawal amount from which the charge has been subtracted is displayed on the display (S206). Furthermore, based on the flag F2(m, n), information necessary to be confirmed by the bank clerk of the center is reverse-displayed and/or highlighted on the display. The image and the information displayed on the center terminal 13 are the same as those in FIGS. 6, 9, and 12.

In this case, by referring to the value of the flag F2(m, n), the presence or absence of information data necessary to be confirmed by the bank clerk of the center is determined. When the information confirmation by the bank clerk of the center is necessary (flag F2(m, n)=1), the information necessary to be confirmed by the bank clerk of the center is reverse displayed and/or highlighted on the display so that the bank clerk of the center may be notified.

Specifically, with a display format different from the format of the supervisor terminal 12, and the information of which the supervisor is notified and the information corrected by the supervisor are reverse-displayed and/or highlighted. In this manner, the bank clerk of the center can easily visually recognize the items he/she needs to confirm while understanding the items confirmed by the supervisor. The case in which the information of which the supervisor is notified and the information corrected by the supervisor are reverse-displayed and/or highlighted in different display formats is explained here. However, it may also be acceptable if only the information corrected by the supervisor is reverse-displayed and/or highlighted. In this manner, the bank clerk of the center can reliably understand the items he/she needs to confirm.

In this case, since the image and the information displayed on the display of the center terminal 13 are the same as those shown in FIGS. 6, 9, and 12, a detailed explanation about the information notification performed here will not be made.

Subsequently, it is determined whether the check is legitimate (S407). For example, check numbers previously issued in the past are transmitted from the server 10 to the center terminal 13 (S305; see FIG. 14) and stored in the storage unit 13a of the center terminal. It is determined whether the previously issued check numbers match the check information data D1(4) corresponding to the check number read by the scanner 14. When the numbers (the previously issued check number and the check number read by the scanner 14) match each other (No in S407), an information representing that the check is illegitimate, e.g. characters “illegitimate”, is displayed on the display like the information shown in FIG. 9 (S409). On the other hand, when the check numbers do not match each other (Yes in S407), an information representing that the check is legitimate, e.g. characters “legitimate”, is displayed on the display in place of the information shown in FIG. 9 (S408).

Subsequently, the bank clerk of the center confirms, on the display, the check image 100, the deposit slip image 200, the item information 300 of the check, and the item information 300 of the deposit slip. When the bank clerk of the center approves the reception processes of the teller and the supervisor (S410), the process in the center terminal 13 is completed (S411). At this time, the final data is transmitted from the center terminal 13 to the server 10 and recorded in the server storage unit 10a (S306; see FIG. 14).

In this manner, in the center terminal 13, since only necessary portions of the check and the deposit slip have to be confirmed, the time required for processing in the center can be considerably reduced.

### Second Embodiment

In the first embodiment, the case in which processes in a reception process system of the bank are performed by the server 10, the teller terminal 11, the supervisor terminal 12, the center terminal 13, the scanner 14, and the currency processing device 15 is explained. In contrast to this, in the second embodiment, by using the configuration of the first embodiment, a case in which a deposit process is performed in the currency processing device 15 will be explained. A withdrawal process is the same as that of the first embodiment.

The configuration of the second embodiment is basically the same as that of the first embodiment. In the second embodiment, only parts different from those in the first embodiment will be described in detail. The explanations about the configuration, the control, and the processes which are not presented here correspond to the explanations discussed in the first embodiment.

### [Description of Devices Included in Reception Process System]

The reception process system is a system that processes a check and a slip received by a teller of a bank from a customer. Devices included in the reception process system for banks will be described below. The reception process system for banks, as shown in FIG. 1, for example, has the server 10, the teller terminal 11, the supervisor terminal 12, the center terminal 13, the scanner 14, and the currency processing device 15. The configuration is the same as that in the first embodiment.

### [Explanation of Functions for Controlling Reception Process System]

With reference to FIG. 5, the control of the reception process system for banks will be described with respect to the functions different from those of the first embodiment. The server 10, the supervisor terminal 12, the center terminal 13, the scanner 14, and the currency processing device 15 have the same functions here as those in the first embodiment. In the teller terminal 11, only functions different from those in the first embodiment will be explained.

### <Teller Terminal>

A recognition unit 73 recognizes an amount data of money calculated by the currency processing device 15. For example, when a banknote is inserted through the money inlet, the recognition unit 73 recognizes the amount data of the banknote. When a coin is put through the money inlet, the recognition unit 73 also recognizes the amount data of the coin.

The information identifying unit 63, based on slip image data, further identifies information of a cash slip as slip information data. Specifically, based on the format of the cash slip recorded in the storage unit 11a of the teller terminal, the information identifying unit 63 recognizes a position information of the slip for reading the information of the cash slip. The information identifying unit 63 then identifies the information of the cash slip as the slip information data based on the position information of the cash slip.

The first image display unit 66 further displays the amount of cash and the information of the cash slip on the display based on the amount data of the cash calculated by the currency processing device 15 and the information data.

When at least one of the teller and the customer approves the amount of cash, the deposit process unit 70 executes a deposit process. For example, when at least one of the teller and the customer approves the amount of cash after the deposit process unit 70 executes a deposit process for a check, the deposit process unit 70 further executes a deposit process for the cash. In this manner, a deposit of a check and cash can be continuously executed.

### [Process of Controlling Reception Process System and Method Thereof]

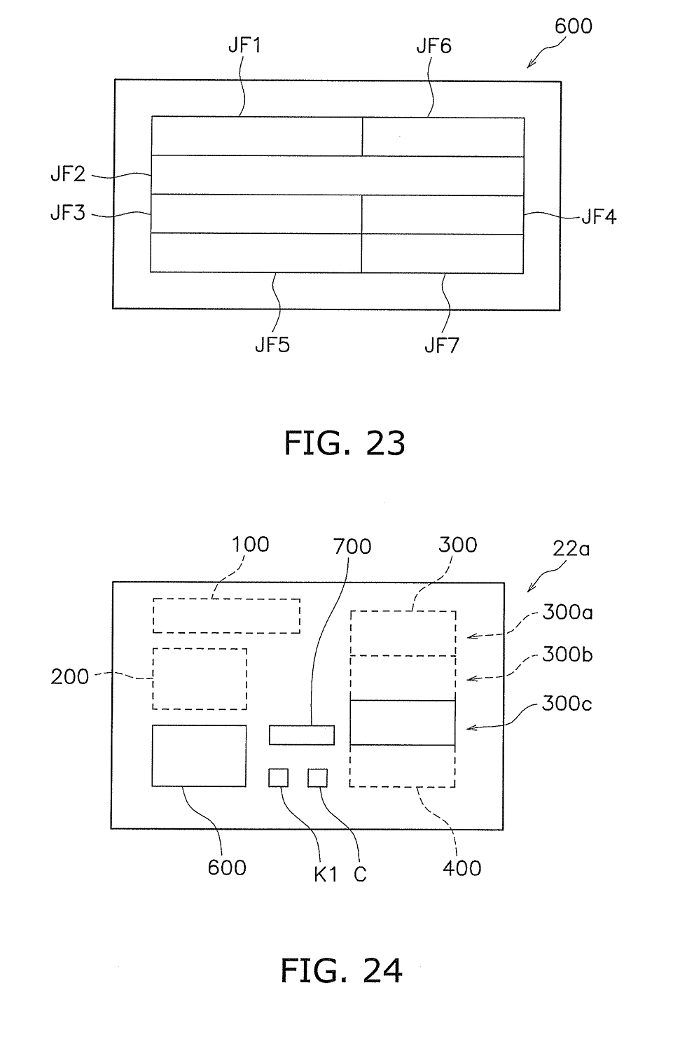

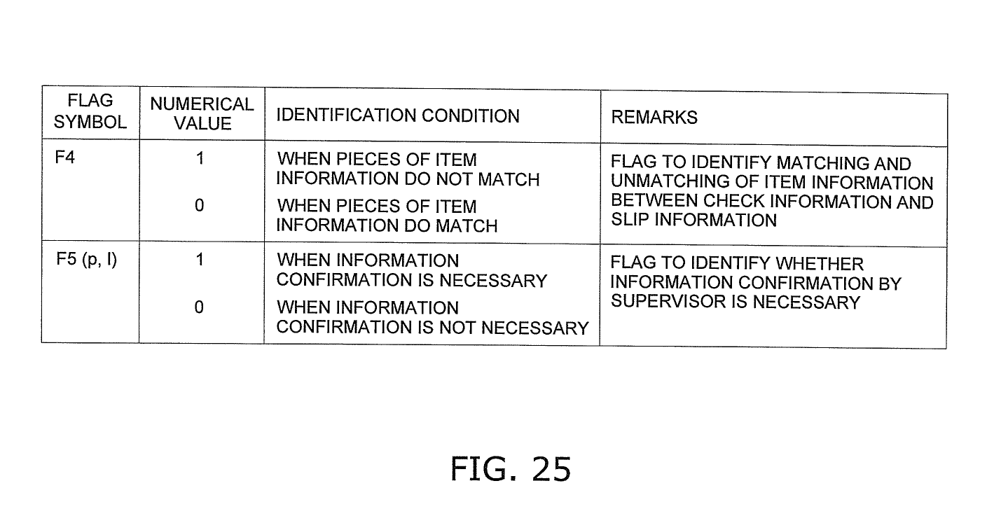

A reception process system for a bank and a method thereof will be explained with reference to FIGS. 23 to 27. In the second embodiment, a detailed explanation of the same control and the same processes as those in the first embodiment will not be made, and only parts different from those in the first embodiment will be explained in detail. Furthermore, in the second embodiment, since the deposit process is the target, a case in which a deposit mode is selected will be explained. Same reference symbols as in the first embodiment denote the same parts in the second embodiment.

Various processes in the terminals 10 to 15 (will be described below), unless otherwise noted, are executed in the control units 10b to 15b of the terminals. Records of the various data in the terminals 10 to 15, unless otherwise noted, are recorded in the storage units 10a to 15a of the terminals. Furthermore, various input processes in the terminals 10 to 13, unless otherwise noted, are performed through input units 10e to 13e of the terminals.

In the system of the second embodiment, the processes in step 1 (S1) and step 2 (S2) of the first embodiment are executed. When the deposit mode is selected (Yes in S2), the teller selects a type of the deposit process (S601). For example, the teller, through the keyboard and/or the mouse, selects an icon to execute a check process or an icon (not shown) to execute a cash process displayed on the display. At this time, the process mode corresponding to the icon selected by the teller is selected. The process mode is either one of a check process mode and a cash process mode.

For example, when the teller selects the icon for the check process (No in S601), the processes in step 3 (S3; see FIG. 15) to step 22 (S22) described in the first embodiment are executed. On the other hand, when the teller selects the icon for the cash process (Yes in S601), the cash process mode is initiated (S602). In the cash process mode, the format of a cash deposit slit is recognized as the format of an object to be read (S603).

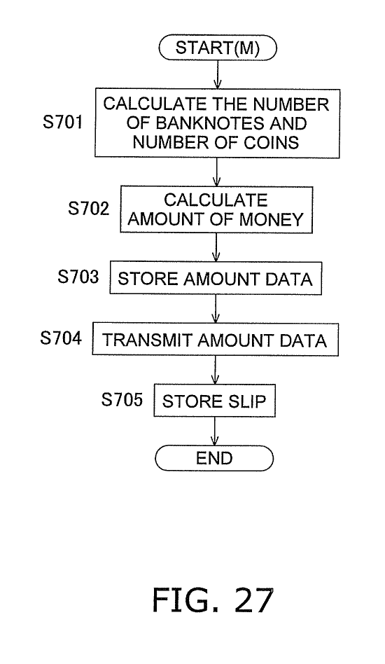

Subsequently, in the currency processing device 15, the customer and/or the teller inserts banknotes and/or coins through the money inlet. The banknotes and/or the coins are sorted by denominations, and the number of banknotes and/or the number of coins is calculated (S701; see FIG. 27). Based on the number of banknotes and/or the number of coins, the amount of the banknotes and/or the amount of coins are calculated (S702). In this case, the amount of the banknotes and/or the amount of the coins are recorded in the storage unit 15a of the currency processing device 15 as amount data Y (S703). At this time, the amount data Y is transmitted from the currency processing device 15 to the teller terminal 11 (S704).

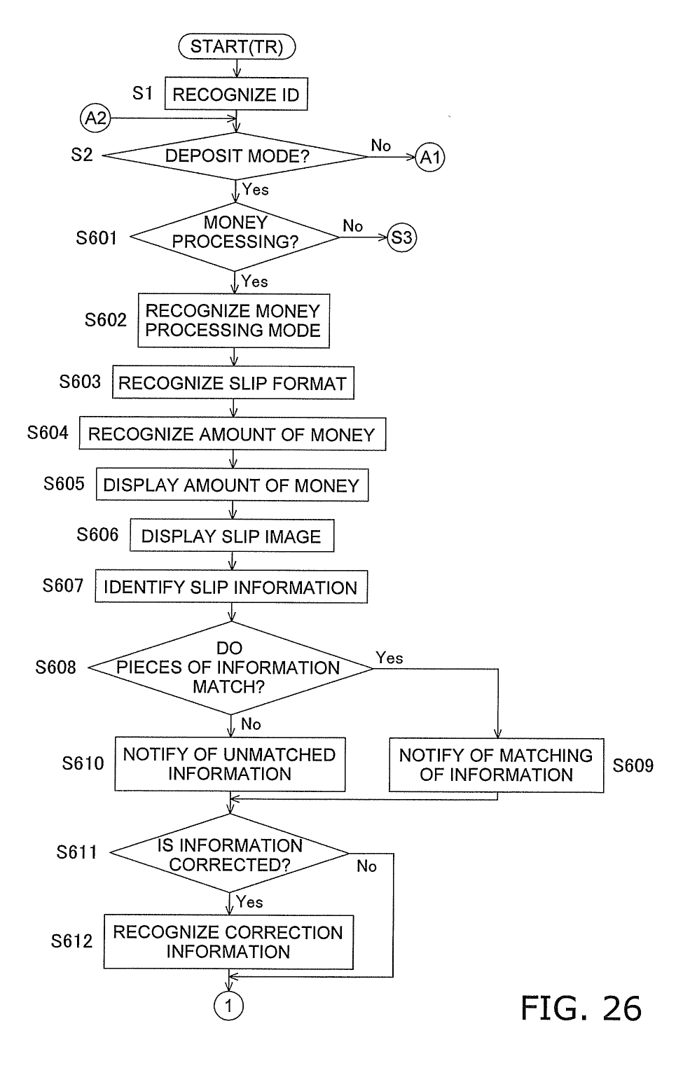

Subsequently, when the teller terminal 11 receives the amount data Y, the amount of money corresponding to this amount data Y is recognized (S604). At this time, as shown in FIG. 26, based on the amount data Y, the money amount 700 is displayed on the display (S605).

Subsequently, the teller sets a cash deposit slip in the scanner 14. At this time, a surface of the cash deposit slip is read by the scanner 14 (S104; see FIG. 19). An image of the cash deposit slip is then recorded as cash-slip image data (S105). The scanner 14 transmits the cash-slip image data from the currency processing device 15 to the teller terminal 11 (S106).

Subsequently, when the teller terminal 11 receives the cash-slip image data read by the scanner 14, the cash-slip image data is recognized in the teller terminal 11. Then, the cash-slip image data is recorded in the storage unit 11a of the teller terminal 11. At this time, in the teller terminal 11, as shown in FIGS. 23 and 24, based on the cash-slip image data, a cash deposit slip image 600 is displayed on the display (S606).

Subsequently, based on the format of the cash deposit slip as shown in FIG. 23, a position (position information for cash slip) where information data is to be read from the cash-slip image data is recognized. At this time, based on the position information for the cash slip, information of the cash deposit slip is identified as the information data for the cash slip. Specifically, a program for OCR is executed. Through a pattern matching technique, characters and/or numbers written on the cash deposit slip are identified as character data (S607). The character data is then recorded in the storage unit 15a of the currency processing device 15.

Cash slip item information JF includes a predetermined number of pieces of item information JF1 to JF7. For example, the cash slip item information includes Name JF1 of a payer, Address JF2 of the payer, Bank name JF3, Account number JF4 into which money is deposited, Total amount JF5, Date JF6, and Signature JF7 (see FIG. 23).

In this case, as the cash slip item information JF, 7 pieces of item information JF1 to JF7 are prepared. However, when a customer completes minimum item information, the deposit process can be performed. For example, the minimum item information includes Date JF6, Total amount JF5, Signature JF7, and Account number JF4, the deposit process can be performed.

The cash slip item information JF will be explained. Character data, each of which is constituted by characters and/or numbers of a different information and corresponding to one of the cash slip item information JF1 to JF7, are each assigned an information data, i.e. cash slip information data D3(p). Reference symbol p is a natural number selected from 1 to 7.

Name JF1 of a payer is assigned to the cash slip information data D3(1). Address JF2 of the payer is assigned to the cash slip information data D3(2). Bank name JF3 is assigned to the cash slip information data D3(3). Account number JF4 into which money is deposited is assigned to the cash slip information data D3(4). Total amount JF5 is assigned to the cash slip information data D3(5). Data JF6 is assigned to the cash slip information data D3(6). Signature JF7 is assigned to the cash slip information data D3(7).

The position information for the cash slip is an information that defines positions of the item information JF1 to JF7 on a cash deposit slip. The position information for the cash slip includes position coordinate data of each of the item information JF1 to JF7. Based on the position coordinate data, the positions of the item information JF 1 to JF7 are specified, and the item information JF1 to JF7 are recognized as character data (or cash slip information data D3(p)) representing the item information.

Subsequently, based on the information data D3(p) of the cash deposit slip and the amount data Y, it is determined whether the information of the cash deposit slip matches the amount of money (S608). Specifically, when the amount of money indicated in the information of the cash deposit slip does not match the amount of the money, a flag F4 is set to 1. The flag F4 is used to identify whether the amounts match. For example, when the amounts do not match, 1 is allocated to the flag F4. When the amounts match each other, 0 is allocated to the flag F4. At this time, the flag F4 is recorded in the storage unit 11a of the teller terminal.

Subsequently, as shown in FIG. 24, based on the information data D3(p) of the cash deposit slip, all of item information 300c of the cash deposit slip are displayed on the display. All the item information 300c of the cash deposit slip are displayed in the same manner as that in FIG. 23. In this state, when the information data D3(5) of the cash deposit slip matches the amount data Y of the money, an image representing “matching amounts” is displayed on the display, as shown in FIG. 9 (S609).

When the information data D3(5) of the cash deposit slip does not match the amount data Y of the money, an amount item within the item information 300c of the cash deposit slip is reverse-displayed and/or highlighted as shown in FIG. 12 (S610). When the value of the flag F4 is found to be 1, the amount item is reverse-displayed and/or highlighted on the display.

It is then determined whether the information of the cash deposit slip has been corrected by the teller (S611). For example, when the teller corrects the information of the cash deposit slip while referring to the cash deposit slip image 600 (Yes in S611), the information data D3(p) corresponding to the information corrected by the teller is recognized as the correction data (S612). For example, when the teller corrects an amount information of the cash deposit slip, the information data D3(5) corresponding to the amount information is recognized as the correction data. The correction data is recorded in the storage unit 11a of the teller terminal.

When the teller has corrected the information of the cash deposit slip, the information corrected by the teller is displayed again on the display. In this case, when the amount included in the information of the cash deposit slip matches the amount of the money, an image representing “matching amounts” is displayed on the display, in place of information as shown in FIG. 9.

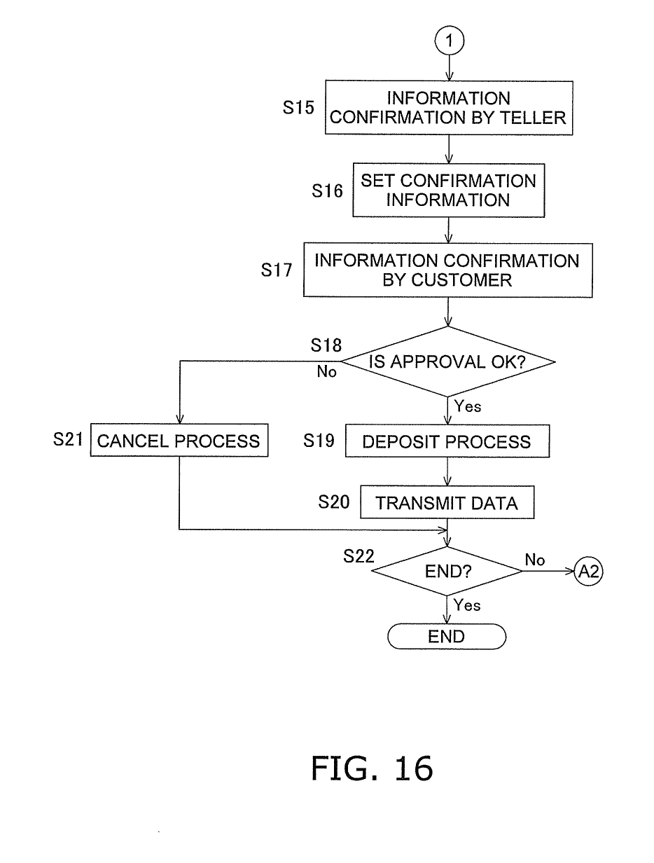

Subsequently, the teller confirms the contents 600 of the image of the cash deposit slip, all of the item information 300c of the cash deposit slip, and the money amount 700 (S15; see FIG. 16). For example, when the teller uses the keyboard and/or the mouse to select the confirmation button K1 (see FIG. 24) displayed on the display, whether or not an information confirmation by the supervisor is necessary is determined. At this time, information necessary to be confirmed by the supervisor is set (S16; see FIG. 16).

For example, based on the information data D3(p) of the cash deposit slip, whether or not an information confirmation by the supervisor is necessary is determined. When it is determined that the information confirmation by the supervisor is necessary, the flag F5(p, l) is set to 1. Reference symbol l is a natural number selected from 1 to 5.

The setting of the flag F5(p, l) for l (lowercase of L) being 1 to 3 is the same as that in step 16 (S16) in the first embodiment. For this reason, a detailed explanation about this setting will not be made.

Subsequently, the process of comparing the information data D3(p) of the cash deposit slip with the condition data is execute. In this case, the condition data is transmitted from the server 10 to the teller terminal 11 (S303; see FIG. 14) and stored in the storage unit 11a of the teller terminal.

For example, it is determined whether the information data D3(5) for the cash slip representing the amount of the cash deposit slip is a predetermined amount data or more. When the information data D3(5) for the cash slip is the predetermined amount data or more, 1 is allocated to the flag F5(p, 4). On the other hand, when the information data D3(5) for the cash slip is smaller than the predetermined amount data, 0 is allocated to the flag F5(p, 4). In this manner, when the amount of money to be deposited is large, the supervisor can be notified of the amount.

Moreover, for example, it is determined whether the information data D3(3) for the cash slip representing a bank into which money is deposited is the same as the bank data of the teller. When the information data D3(3) for the cash slip is different from the bank data of the teller, 1 is allocated to the flag F5(p, 5). On the other hand, when the information data D3(3) for the cash slip is the same as the bank data of the teller, 0 is allocated to the flag F5(p, 5). In this manner, when the bank into which money is deposited is not the bank (teller's bank) of the teller, the supervisor can be notified of the bank name.

When the process described above is executed, whether or not an information confirmation by the supervisor is necessary can be determined. For example, when the value of the flag F5(p, l) is 1, the supervisor is notified of the information necessary to be confirmed.

The customer or both the teller and the customer then confirm the images and the information on the display (S17; see FIG. 16). It is determined whether or not the customer or both the teller and the customer approve the images and the information on the display (S18; see FIG. 16). And, when the customer or both the teller and the customer approves the images and the information on the display (Yes in S18; see FIG. 16), a deposit process is executed (S19; see FIG. 16). Specifically, in this case, when the teller selects, through the input unit such as the keyboard and/or the mouse, an approval button displayed on the display, the deposit process is executed.

For example, when the deposit process ends in the teller terminal 11, the teller terminal 11 notifies the currency processing device 15 of the end of the deposit process. The currency processing device 15 causes the transportation mechanism to convey banknotes and/or coins from the escrow unit to a storing unit for the deposit process so as to be stored in the storing unit (S705; see FIG. 27). When the deposit process ends in the teller terminal 11, the currency processing device 15 also notifies the server 10 of the end of the deposit process. At this time, the server 10 pays the amount of money calculated by the currency processing device 15, i.e. the amount written on the cash deposit slip, into an account of the customer (S304; see FIG. 14).

Subsequently, various data are transmitted from the teller terminal 11 to the supervisor terminal 12 (S20; see FIG. 16). For example, the information data D3(p) for the cash slip is transmitted from the teller terminal 11 to the supervisor terminal 12. In the presence of the correction data, the information data D3(p) for the cash slip including the correction data is transmitted from the teller terminal 11 to the supervisor terminal 12. The flag F5(p, l) is also transmitted from the teller terminal 11 to the supervisor terminal 12. The cash-slip image data is transmitted from the teller terminal 11 to the supervisor terminal 12. Furthermore, the amount data Y is transmitted from the teller terminal 11 to the supervisor terminal 12.

On the other hand, when the customer or both the teller and the customer do not approve the item information 300c of the cash deposit slip (No in S18; see FIG. 16), the process is cancelled (S21; see FIG. 16). In this case, in the teller terminal 11, the cash-slip image data and the information data D3(p) for the cash slip are erased from the storage unit 11a of the teller terminal.

A deposit icon, a withdrawal icon, and an end icon (not shown) that ends the reception process are then displayed on the display (S22; see FIG. 16). For example, when the teller selects the end icon (Yes in S22; see FIG. 16), the process of the system ends. On the other hand, when the teller selects a continue icon (not shown) (No in S22; see FIG. 16), the process is re-executed from step 2 (S2).

In the supervisor terminal 12 and the center terminal 13, the similar control and the similar processes as those in the first embodiment are executed. For this reason, an explanation will be made with reference to FIGS. 17 and 18. In the second embodiment, the processes in S201, S203, S205, and S206 in FIG. 17 are not executed. The processes in S401, S403, S405, and S406-S409 in FIG. 18 are not executed.

For example, in the supervisor terminal 12, in place of the image of the deposit slip for the check, the image of the cash deposit slip is displayed on the display (S202; FIG. 17). In place of the item information 300 of the deposit slip for the check, the item information 300c of the cash deposit slip is displayed on the display (S204). Furthermore, also in the supervisor terminal 12, as shown in FIGS. 23 and 24, based on the amount data Y, the money amount 700 is displayed on the display.

Subsequently, the supervisor confirms the various pieces of information displayed on the display (S207). In this case, based on the flag F5(p, l) set in the teller terminal 11, information necessary to be confirmed by the supervisor is reverse-displayed and/or highlighted on the display. When the supervisor uses the keyboard and/or the mouse to correct the information displayed on the display, 1 is allocated to the flag F5(p, 1) corresponding to the corrected information. When the supervisor approves the information displayed on the display, approval data and various data are transmitted from the supervisor terminal 12 to the center terminal 13 at a predetermined time (S208, S209).

Subsequently, in the center terminal 13, the same control and the same processes as those in the supervisor terminal 12 are executed (S402, S404). Also in the center terminal 13, as shown in FIGS. 23 and 24, based on the amount data Y, the money amount 700 is displayed on the display.

When the bank clerk of the center finally approves the information (S410), the process in the center terminal 13 is completed (S411). At this time, the final data is transmitted from the center terminal 13 to the server 10 and recorded on the server storage unit 10a (S306; see FIG. 14).

### Another Embodiment

The above embodiments exemplify the case in which the final data is stored in the hard disk of the server 10. However, the final data may also be stored in an external storage device on a network. For example, a database may be arranged on the network separately of the server 10, and the image data, the information data, data (charge data and withdrawal amount data from which the charge has been subtracted) related to a withdrawal process, amount data of money, and the like may be stored in the database. In this manner, the check of the stored data can be more reliably assured.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A reception process system for handling a deposit/withdrawal request from a customer, comprising:
a scanner configured to generate a check image based on check received from the customer and generates a slip image based on a slip related to the check;
a bank terminal, including
an identifying unit configured to extract check information from the check image and extracts slip information from the slip image,
a first display unit configured to display the check information and the slip information,
an input unit configured to receive an input information,
a confirmation determining unit configured to, based on at least one of the check information, the slip information, and the input information from the input unit, determine whether or not a reconfirmation for at least one of the check information, the slip information, and the input information is necessary, and
a communication unit configured to transmit the check information, the slip information, and the determination result determined by the confirmation determining unit to an external device; and
a center terminal including a second display unit configured to display the check information and the slip information received from the bank terminal and to display information determined necessary to be reconfirmed in a way so as to be distinguished from information determined not necessary to be reconfirmed.

2. The reception process system according to claim 1, wherein
the confirmation determining unit determines that the reconfirmation is necessary if information included in the check information or the slip information is changed by the input information which is input from the input unit.

3. The reception process system according to claim 1, wherein
the first display unit and the second display unit display images including the information determined necessary to be reconfirmed.

4. The reception process system according to claim 3, wherein
the first display unit and the second display unit display region including the information determined necessary to be reconfirmed on the images in a way so as to be distinguished from region other than the region including the information determined necessary to be reconfirmed.

5. The reception process system according to claim 1, further comprising
a storage unit configured to store the check image and at least one of the slip image and the slip information.

6. The reception process system according to claim 1, wherein
the bank terminal further includes
a recognition unit configured to recognize a terminal user and an ability level of the terminal user, and
the confirmation determining unit determines whether or not the reconfirmation is necessary based on the ability level.

7. The reception process system according to claim 1, wherein
the confirmation determining unit determines that the reconfirmation is necessary when an information requested to be reconfirmed is input from the input unit.

8. The reception process system according to claim 1, wherein
the confirmation determining unit determines that the reconfirmation is necessary if the check has been issued by banks other than a bank associated with the reception process system.

9. A reception process method for processing a deposit/withdrawal request from a customer, comprising:
generating a check image based on check received from the customer and generates a slip image based on a slip related to the check;
extracting check information from the check image and extracting slip information from the slip image;
displaying the check information and the slip information on a first display unit;
receiving an input information;
determining whether or not a reconfirmation for at least one of the check information, the slip information, and the input information is necessary, based on at least one of the check information, the slip information, and the input information;
transmitting the check information, the slip information, and the determination result of the reconfirmation to an external device;
displaying the check information and the slip information on a second display unit; and
displaying information determined necessary to be reconfirmed in a way so as to be distinguished from information determined not necessary to be reconfirmed.

10. The reception process method according to claim 9, wherein
in the step of determining necessity of reconfirmation, it is determined that reconfirmation is necessary if information included in the check information or the slip information is changed by the input information which is input from the input unit.

11. The reception process method according to claim 9, further comprising displaying an image including the information determined necessary to be reconfirmed on the first display unit and the second display unit.

12. The reception process method according to claim 11, further comprising displaying region including the information determined to be necessary to be reconfirmed on the image in a way so as to be distinguished from region other than the region including the information determined necessary to be reconfirmed.

13. The reception process method according to claim 9, further comprising storing the check image and at least one of the slip image and the slip information.

14. The reception process method according to claim 9, further comprising
recognizing an ability level of a user, wherein
in the step of determining necessity of reconfirmation, it is determined whether or not the reconfirmation is necessary based on the ability level.

15. The reception process method according to claim 9, wherein
in the step of determining necessity of reconfirmation, it is determined that the reconfirmation is necessary if an information requested to be reconfirmed is input by a user.

16. The reception process method according to claim 9, wherein
in the step of determining necessity of reconfirmation, it is determined the reconfirmation is necessary if the check has been issued by banks other than a bank associated with the reception process system.
